(19) United States
(12) Patent Application Publication
(10) Pub. No.: US 2026/0176060 A1
(43) Pub. Date: Jun. 25, 2026

(54) EMPTYING REFUSE CONTAINERS BY AGITATION

(71) Applicant: The Heil Co., Chattanooga, TN (US)

(72) Inventors: Alexander Davis McDougal, Chattanooga, TN (US); Anthony Sean Ceglia, Franklin, TN (US)

(21) Appl. No.: 19/424,059

(22) Filed: Dec. 17, 2025

Related U.S. Application Data
(60) Provisional application No. 63/736,455, filed on Dec. 19, 2024.

(51) Int. Cl. B65F 3/04

(52) U.S. Cl. CPC B65F 3/041; B65F 2210/168; B65F 2210/20

(57) ABSTRACT

Methods and systems for emptying refuse containers by agitation are disclosed. A refuse collection vehicle includes: a wheeled chassis; a hopper supported on the wheeled chassis; and a lift arm assembly configured to unload refuse from a refuse container into the hopper. The lift arm assembly is movable by actuators. The refuse collection vehicle includes: a camera mounted to the refuse collection vehicle; and a control system communicably coupled to the camera and the actuators. The control system includes one or more processors configured to perform operations including: obtaining, from the camera, image data depicting an interior of the refuse container after the lift arm assembly has raised the refuse container; determining, based on the image data, whether agitation of the refuse container is recommended to dislodge the refuse from the refuse container; and in response, causing the refuse collection vehicle to perform one or more actions.

### CROSS-REFERENCE TO RELATED APPLICATION

This application claims the benefit of the U.S. Provisional Patent Application No. 63/736,455 filed Dec. 19, 2024, which is incorporated herein by reference in its entirety.

### TECHNICAL FIELD

This disclosure generally relates to techniques for emptying refuse containers into refuse collection vehicles.

### BACKGROUND

A refuse collection company may operate a fleet of refuse collection vehicles that operate regularly to collect refuse from the containers of various customers and transport the refuse to a processing site. A refuse collection vehicle may lift a refuse container to dump refuse from the refuse container into a hopper of a refuse collection vehicle. The refuse container may not be emptied upon first lifting the refuse container. For example, refuse from the refuse container may stick to the sides and bottom of the refuse container. Agitation of the refuse container can dislodge stuck refuse from the refuse container.

Refuse container overages may pose complications for refuse collection and customer billing. An overage can occur, for example, when a container is filled above its rim, e.g., causing the lid to not close completely. If a customer consistently overfills their container(s), creating an overage, the refuse collection company may lose revenue by collecting more refuse than the company agreed to collect from the customer. Moreover, an overfilled container may lead to operational problems in the mechanism(s) that empty the container into the vehicle. Contracts between the company and its customers are priced, and the containers are sized, based on an expected amount of refuse to be collected. Accordingly, a refuse collection company typically charges an overage fee for an overfilled container.

### SUMMARY

Implementations of the present disclosure are generally directed to emptying refuse containers through agitation of the container. The amount of refuse within a refuse container can be estimated using computer vision techniques to determine whether agitation of the refuse container is recommended to dislodge the refuse from the refuse container into a hopper of a refuse collection vehicle. In some examples, the refuse container is automatically agitated in response to the determination. An estimated volume of refuse within the refuse container can be used to estimate volume of refuse within the refuse collection vehicle and determine when to route the refuse collection vehicle to a refuse collection facility. The estimated volume of refuse within the refuse container can be used to monitor refuse volume collected from customers.

Image data can be generated by camera(s), other camera device(s), and/or other device(s) that are components of a refuse collection vehicle (refuse collection vehicle) or that are otherwise in proximity to the refuse collection vehicle. During (or after) the collection of refuse by a refuse collection vehicle, one or more images of refuse can be generated by camera(s) that are in, on, or in proximity to the refuse collection vehicle. The image(s) can be analyzed to detect presence of refuse in the container, such as refuse within the refuse container that exceeds a maximum amount of refuse. In some examples, the determination that agitation of the refuse container is recommended can trigger the sending of an agitation notification to one or more computing devices, and/or other actions.

In an example implementation, a refuse collection vehicle includes: a wheeled chassis; a hopper supported on the wheeled chassis; and a lift arm assembly configured to unload refuse from a refuse container into the hopper. The lift arm assembly is movable by one or more actuators. The refuse collection vehicle includes: a camera mounted to the refuse collection vehicle; and a control system communicably coupled to the camera and the one or more actuators, the control system including one or more processors and a data store coupled to the one or more processors having instructions stored thereon which, when executed by the one or more processors, causes the one or more processors to perform operations including: obtaining, from the camera, image data depicting an interior of the refuse container after the lift arm assembly has raised the refuse container to dump the refuse into the hopper; determining, based on the image data, whether agitation of the refuse container is recommended to dislodge the refuse from the refuse container; and in response to determining whether agitation of the refuse container is recommended to dislodge the refuse from the refuse container, causing the refuse collection vehicle to perform one or more actions.

In an aspect combinable with the example implementation, determining, based on the image data, whether agitation of the refuse container is recommended to dislodge the refuse from the refuse container includes determining that agitation of the refuse container is recommended to dislodge the refuse from the refuse container.

In another aspect combinable with any of the previous aspects, the operations include: in response to determining that agitation of the refuse container is recommended to dislodge the refuse from the refuse container, outputting a control signal to the one or more actuators that causes the lift arm assembly to move automatically to agitate the refuse container.

In another aspect combinable with any of the previous aspects, operations include: determining, based on the image data, a duration of agitation of the refuse container. The control signal causes the lift arm assembly to move automatically to agitate the refuse container for the determined duration.

In another aspect combinable with any of the previous aspects, the operations include: in response to determining that agitation of the refuse container is recommended to dislodge the refuse from the refuse container, generating a notification that agitation of the refuse container is recommended.

In another aspect combinable with any of the previous aspects, the notification includes at least one of: a visual notification presented on a display inside a cab of the refuse collection vehicle; a light illuminated inside the cab of the refuse collection vehicle; or an audible notification broadcast inside the cab of the refuse collection vehicle.

In another aspect combinable with any of the previous aspects, the operations include: repeatedly: after causing the refuse collection vehicle to perform the one or more actions, obtaining, from the camera, additional image data depicting the interior of the refuse container; determining, based on the additional image data, whether additional agitation of the refuse container is recommended to dislodge the refuse from the refuse container; and in response to determining whether agitation of the refuse container is recommended to dislodge the refuse from the refuse container, causing the refuse collection vehicle to perform one or more actions, until determining that additional agitation of the refuse container is not recommended to dislodge the refuse from the refuse container.

In another aspect combinable with any of the previous aspects, determining, based on the image data, whether agitation of the refuse container is recommended to dislodge the refuse from the refuse container includes determining that agitation of the refuse container is not recommended to dislodge the refuse from the refuse container.

In another aspect combinable with any of the previous aspects, the operations include: in response to determining that agitation of the refuse container is not recommended to dislodge the refuse from the refuse container, outputting a control signal to the one or more actuators that prevents the lift arm assembly from moving to agitate the refuse container.

In another aspect combinable with any of the previous aspects, the operations include: in response to determining that agitation of the refuse container is not recommended to dislodge the refuse from the refuse container, outputting a control signal to the one or more actuators that causes the lift arm assembly to automatically move to lower the refuse container to the ground.

In another aspect combinable with any of the previous aspects, the operations include: in response to determining that agitation of the refuse container is not recommended to dislodge the refuse from the refuse container, generating a notification that agitation of the refuse container is not recommended.

In another aspect combinable with any of the previous aspects, the notification includes: a visual notification presented on a display inside a cab of the refuse collection vehicle; a light illuminated inside the cab of the refuse collection vehicle; or an audible notification broadcast inside the cab of the refuse collection vehicle.

In another aspect combinable with any of the previous aspects, the refuse collection vehicle includes a lift arm sensor configured to generate lift arm sensor data indicating an operational state of the lift arm assembly, the operations including: obtaining, from the lift arm sensor, the lift arm sensor data; and determining, using the lift arm sensor data, that a position of the lift arm assembly satisfies position criteria. Obtaining the image data from the camera is performed in response to determining that that the position of the lift arm assembly satisfies the position criteria.

In another aspect combinable with any of the previous aspects, determining, using the lift arm sensor data, that the position of the lift arm assembly satisfies position criteria includes determining that the lift arm assembly is holding the refuse container in an inverted position.

In another aspect combinable with any of the previous aspects, determining, using the lift arm sensor data, that the position of the lift arm assembly satisfies position criteria includes: determining a time duration that the lift arm assembly has held the refuse container in an inverted position; and determining that the time duration satisfies a threshold time duration.

In another aspect combinable with any of the previous aspects, determining, based on the image data, whether agitation of the refuse container is recommended to dislodge the refuse from the refuse container includes: providing the image data as input to at least one container analysis model trained, using at least one machine learning (ML) algorithm, to output a classification of the image data. The classification indicates a degree of emptiness of the refuse container.

In another aspect combinable with any of the previous aspects, determining, based on the image data, whether agitation of the refuse container is recommended to dislodge the refuse from the refuse container includes: determining that the degree of emptiness of the refuse container does not satisfy an emptiness threshold; and in response to determining the degree of emptiness of the refuse container does not satisfy the emptiness threshold, determining that agitation of the refuse container is recommended to dislodge the refuse from the refuse container.

In another aspect combinable with any of the previous aspects, determining, based on the image data, whether agitation of the refuse container is recommended to dislodge the refuse from the refuse container includes: determining that the degree of emptiness of the refuse container satisfies an emptiness threshold; and in response to determining the degree of emptiness of the refuse container satisfies the emptiness threshold, determining that agitation of the refuse container is not recommended to dislodge the refuse from the refuse container.

In another aspect combinable with any of the previous aspects, the operations including: obtaining identifying information for the refuse container; determining, using the image data, an estimated volume of the refuse in the refuse container; and storing data including the identifying information for the refuse container and the estimated volume of the refuse in the refuse container.

In another aspect combinable with any of the previous aspects, the operations including: determining that the estimated volume of the refuse in the refuse container exceeds a threshold volume for the refuse container; and in response to determining that the estimated volume of the refuse in the refuse container exceeds the threshold volume for the refuse container, transmitting a notification to a customer associated with the refuse container indicating that the estimated volume exceeds the threshold volume for the refuse container.

In another aspect combinable with any of the previous aspects, the operations including: obtaining, from the camera, image data depicting interiors of a plurality of containers serviced by the refuse collection vehicle during servicing of the plurality of containers; determining, using the image data, a respective estimated volume of the refuse in each of the plurality of containers; and determining an estimated volume of refuse within a storage body of the refuse collection vehicle based on the respective estimated volumes of the refuse in each of the plurality of containers.

In another aspect combinable with any of the previous aspects, the operations including: determining that the estimated volume of the refuse within the storage body of the refuse collection vehicle satisfies a threshold volume for the storage body; and in response to determining that the estimated volume of the refuse within the storage body of the refuse collection vehicle satisfies the threshold volume for the storage body, routing the refuse collection vehicle to a refuse collection facility.

In another aspect combinable with any of the previous aspects, the refuse collection vehicle further includes a light source configured to illuminate the interior of the refuse container when unloading the refuse from the refuse container into the hopper.

In another aspect combinable with any of the previous aspects, the control system includes an onboard computing device located in the refuse collection vehicle.

In another aspect combinable with any of the previous aspects, the refuse collection vehicle further includes a temperature sensor, the operations including: obtaining, from the temperature sensor, temperature data indicating an environmental temperature at a location of the refuse collection vehicle. The determining whether agitation of the refuse container is recommended to dislodge the refuse from the refuse container is based on the image data and the temperature data.

In another aspect combinable with any of the previous aspects, determining, based on the image data and the temperature data, whether agitation of the refuse container is recommended to dislodge the refuse from the refuse container includes providing the image data and the temperature data as input to at least one container analysis model trained, using at least one machine learning (ML) algorithm, to output a classification of the input. The classification indicates whether agitation of the refuse container is recommended.

In another aspect combinable with any of the previous aspects, the operations including: determining, based on the temperature data, that the environmental temperature at the location of the refuse collection vehicle is below a threshold temperature; determining, based on the image data, that a degree of emptiness of the refuse container does not satisfy a threshold degree of emptiness; and in response to determining that the environmental temperature at the location of the refuse collection vehicle is below a threshold temperature and the degree of emptiness of the refuse container does not satisfy the threshold degree of emptiness, determining that agitation of the refuse container is recommended to dislodge the refuse from the refuse container.

In another example implementation, a method includes: obtaining, from a camera mounted to a refuse collection vehicle, image data depicting an interior of a refuse container while the refuse container is inverted over a hopper of the refuse collection vehicle; determining, based on the image data, whether agitation of the refuse container is recommended to dislodge refuse from the refuse container; and in response to determining whether agitation of the refuse container is recommended to dislodge refuse from the refuse container, causing the refuse collection vehicle to perform one or more actions.

In an aspect combinable with the example implementation, determining, based on the image data, whether agitation of the refuse container is recommended to dislodge refuse from the refuse container includes determining that agitation of the refuse container is recommended to dislodge refuse from the refuse container.

In an aspect combinable with any of the previous aspects, the method includes: in response to determining that agitation of the refuse container is recommended to dislodge the refuse from the refuse container, outputting a control signal to one or more actuators that causes a lift arm assembly to move automatically to agitate the refuse container. The lift arm assembly is configured to unload refuse from the refuse container into the hopper and is movable by the one or more actuators.

In an aspect combinable with any of the previous aspects, the method includes: determining, based on the image data, a duration of agitation of the refuse container. The control signal causes the lift arm assembly to move automatically to agitate the refuse container for the determined duration.

In an aspect combinable with any of the previous aspects, the method includes: in response to determining that agitation of the refuse container is recommended to dislodge the refuse from the refuse container, generating a notification that agitation of the refuse container is recommended.

In an aspect combinable with any of the previous aspects, the notification includes at least one of: a visual notification presented on a display inside a cab of the refuse collection vehicle; a light illuminated inside the cab of the refuse collection vehicle; or an audible notification broadcast inside the cab of the refuse collection vehicle.

In an aspect combinable with any of the previous aspects, the method includes repeatedly: after causing the refuse collection vehicle to perform the one or more actions, obtaining, from the camera, additional image data depicting the interior of the refuse container; determining, based on the additional image data, whether additional agitation of the refuse container is recommended to dislodge the refuse from the refuse container; and in response to determining whether agitation of the refuse container is recommended to dislodge the refuse from the refuse container, causing the refuse collection vehicle to perform one or more actions, until determining that additional agitation of the refuse container is not recommended to dislodge the refuse from the refuse container.

In an aspect combinable with any of the previous aspects, determining, based on the image data, whether agitation of the refuse container is recommended to dislodge the refuse from the refuse container includes determining that agitation of the refuse container is not recommended to dislodge the refuse from the refuse container.

In an aspect combinable with any of the previous aspects, the method includes: in response to determining that agitation of the refuse container is not recommended to dislodge the refuse from the refuse container, outputting a control signal to one or more actuators that prevents a lift arm assembly from moving to agitate the refuse container. The lift arm assembly is configured to unload refuse from the refuse container into the hopper and is movable by the one or more actuators.

In an aspect combinable with any of the previous aspects, the method includes: in response to determining that agitation of the refuse container is not recommended to dislodge the refuse from the refuse container, outputting a control signal to one or more actuators that causes a lift arm assembly to automatically move to lower the refuse container to the ground. The lift arm assembly is configured to unload refuse from the refuse container into the hopper and is movable by the one or more actuators.

In an aspect combinable with any of the previous aspects, the method includes: in response to determining that agitation of the refuse container is not recommended to dislodge the refuse from the refuse container, generating a notification that agitation of the refuse container is not recommended.

In an aspect combinable with any of the previous aspects, the notification includes at least one of: a visual notification presented on a display inside a cab of the refuse collection vehicle; a light illuminated inside the cab of the refuse collection vehicle; or an audible notification broadcast inside the cab of the refuse collection vehicle.

In an aspect combinable with any of the previous aspects, the refuse collection vehicle includes a lift arm sensor configured to generate lift arm sensor data indicating an operational state of a lift arm assembly. The lift arm assembly is configured to unload refuse from the refuse container into the hopper and is movable by the one or more actuators, the method including: obtaining, from the lift arm sensor, the lift arm sensor data; and determining, using the lift arm sensor data, that a position of the lift arm assembly satisfies position criteria. Obtaining the image data from the camera is performed in response to determining that that the position of the lift arm assembly satisfies the position criteria.

In an aspect combinable with any of the previous aspects, determining, using the lift arm sensor data, that the position of the lift arm assembly satisfies position criteria includes determining that the lift arm assembly is holding the refuse container in an inverted position.

In an aspect combinable with any of the previous aspects, determining, using the lift arm sensor data, that the position of the lift arm assembly satisfies position criteria includes: determining a time duration that the lift arm assembly has held the refuse container in an inverted position; and determining that the time duration satisfies a threshold time duration.

In an aspect combinable with any of the previous aspects, determining, based on the image data, whether agitation of the refuse container is recommended to dislodge the refuse from the refuse container includes providing the image data as input to at least one container analysis model trained, using at least one machine learning (ML) algorithm, to output a classification of the image data. The classification indicates a degree of emptiness of the refuse container.

In an aspect combinable with any of the previous aspects, the method includes: determining that the degree of emptiness of the refuse container does not satisfy an emptiness threshold; and in response to determining the degree of emptiness of the refuse container does not satisfy the emptiness threshold, determining that agitation of the refuse container is recommended to dislodge the refuse from the refuse container.

In an aspect combinable with any of the previous aspects, the method includes: determining that the degree of emptiness of the refuse container satisfies an emptiness threshold; and in response to determining the degree of emptiness of the refuse container satisfies the emptiness threshold, determining that agitation of the refuse container is not recommended to dislodge the refuse from the refuse container.

In an aspect combinable with any of the previous aspects, the method includes: obtaining identifying information for the refuse container; determining, using the image data, an estimated volume of refuse inside the refuse container; and storing data including the identifying information for the refuse container and the estimated volume of refuse inside the refuse container.

In an aspect combinable with any of the previous aspects, the method includes determining that the estimated volume of refuse inside the refuse container exceeds a threshold volume for the refuse container; and in response to determining that the estimated volume of refuse inside the refuse container exceeds the threshold volume for the refuse container, transmitting a notification to a customer associated with the refuse container indicating that the estimated volume exceeds the threshold volume for the refuse container.

In an aspect combinable with any of the previous aspects, the method includes: obtaining, from the camera, image data depicting interiors of a plurality of containers serviced by the refuse collection vehicle; determining, using the image data, a respective estimated volume of the refuse in each of the plurality of containers; and determining an estimated volume of refuse inside a storage body of the refuse collection vehicle based on the respective estimated volumes of the refuse in each of the plurality of containers.

In an aspect combinable with any of the previous aspects, the method includes: determining that the estimated volume of the refuse inside the storage body satisfies a threshold volume; and in response to determining that the estimated volume of refuse inside a storage body satisfies the threshold volume, routing the refuse collection vehicle to a refuse collection facility.

In an aspect combinable with any of the previous aspects, the method includes illuminating the interior of the refuse container with a light source when unloading the refuse from the refuse container into the hopper.

In an aspect combinable with any of the previous aspects, the method is performed by a control system including an onboard computing device located in the refuse collection vehicle.

In an aspect combinable with any of the previous aspects, the refuse collection vehicle further includes a temperature sensor, the method including: obtaining, from the temperature sensor, temperature data indicating an environmental temperature at a location of the refuse collection vehicle. The determining whether agitation of the refuse container is recommended to dislodge the refuse from the refuse container is based on the image data and the temperature data.

In an aspect combinable with any of the previous aspects, determining, based on the image data and the temperature data, whether agitation of the refuse container is recommended to dislodge the refuse from the refuse container includes providing the image data and the temperature data as input to at least one container analysis model trained, using at least one machine learning (ML) algorithm, to output a classification of the input. The classification indicates whether agitation of the refuse container is recommended.

In an aspect combinable with any of the previous aspects, the method includes: determining, based on the temperature data, that the environmental temperature at the location of the refuse collection vehicle is below a threshold temperature; determining, based on the image data, that a degree of emptiness of the refuse container does not satisfy a threshold degree of emptiness; and in response to determining that the environmental temperature at the location of the refuse collection vehicle is below a threshold temperature and the degree of emptiness of the refuse container does not satisfy the threshold degree of emptiness, determining that agitation of the refuse container is recommended to dislodge the refuse from the refuse container.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that aspects and features in accordance with the present disclosure can include any combination of the aspects and features described herein. That is, aspects and features in accordance with the present disclosure are not limited to the combinations of aspects and features specifically described herein, but also include any combination of the aspects and features provided.

Among other advantages, implementations of the systems and methods described herein may reduce wear and tear on components of refuse collection vehicles and refuse containers, extending the life of the components. The vehicle can operate to agitate (e.g., shake) a container only when agitation of the refuse container is needed to dislodge refuse from the container, and can prevent unnecessary agitation of the container when agitation of the refuse container is not needed. Additionally, a hydraulic cylinder cushion function can be selectively turned off when agitation of the refuse container is needed to dislodge refuse from a refuse container, and can be selectively kept on when agitation of the refuse container is not needed to dislodge refuse from a refuse container. As a result, wear on the hydraulic cylinders can be minimized. The refuse collection vehicle can be controlled to permit agitation of a refuse container until refuse dislodges from the container, at which point the refuse collection vehicle can be controlled to prevent agitation of the refuse container. This reduces the total amount of time that agitation of the refuse container is performed by the refuse collection vehicle, which reduces wear on the refuse collection vehicle. In some cases, when agitation of the refuse container is not recommended, the vehicle can prevent agitation of the container. This can prevent operators from overusing agitation, reducing wear and damage on the lift arm and/or fork assembly over time. Furthermore, reducing the amount of time that a refuse container is agitated reduces wear on the refuse container. Reducing the amount of time that a refuse container is agitated also reduces hydraulic run-time. Reduced hydraulic run-time results in reduced fuel consumption of the refuse collection vehicle, reduced likelihood of hydraulic leaks, reduced likelihood of hydraulic pressure spikes, and improved hydraulic fluid quality.

The disclosed techniques can provide an advantage of improved efficiency of refuse collection. For example, efficiency can be improved by reducing the amount of refuse remaining in containers after collection and therefore maximizing the amount of refuse collected in a collection cycle. Furthermore, the described solution enables automatic operation of the cylinder cushion function, reducing the need for time-consuming operator actions such as entering a password to permit disabling the cylinder cushion function. This can also result in improved safety by requiring fewer operator actions that might distract and/or tire the operator of the refuse collection vehicle.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1A shows an example system for emptying refuse containers into refuse collection vehicles by agitation, according to implementations of the present disclosure.

FIG. 1B shows an example schematic of a refuse collection vehicle, according to implementations of the present disclosure.

FIG. 2A shows an example refuse collection vehicle and refuse container prior to agitation of the refuse container, according to implementations of the present disclosure.

FIG. 2B shows the example refuse collection vehicle and refuse container during agitation of the refuse container, according to implementations of the present disclosure.

FIG. 3A shows an example camera image of the non-empty refuse container above the hopper of the vehicle, according to implementations of the present disclosure.

FIG. 3B shows an example camera image of the empty refuse container above the hopper of the vehicle, according to implementations of the present disclosure.

FIG. 4 shows a flow diagram of an example process for emptying refuse containers into refuse collection vehicles by agitation, according to implementations of the present disclosure.

FIG. 5 shows an example computing system, according to implementations of the present disclosure.

### DETAILED DESCRIPTION

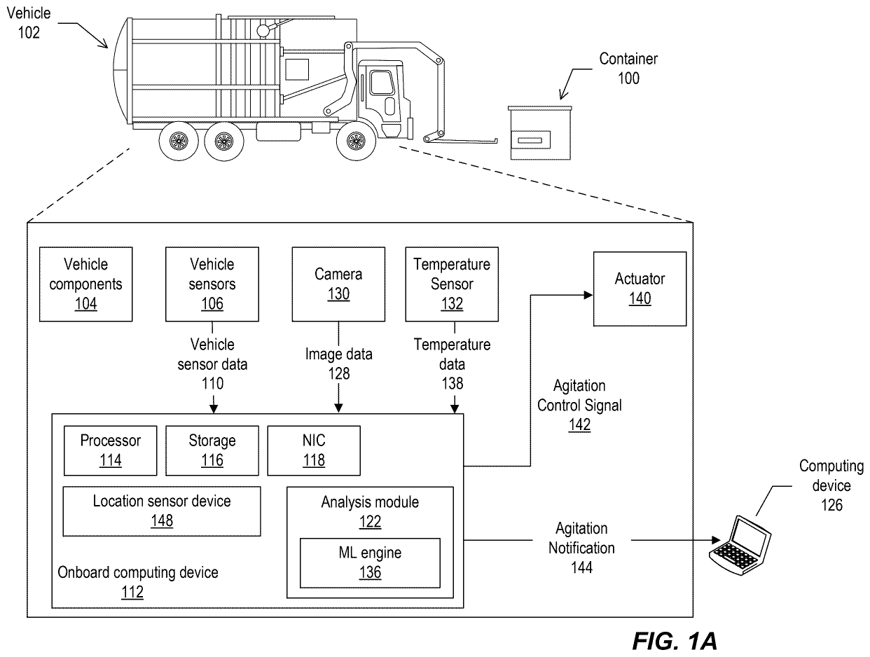

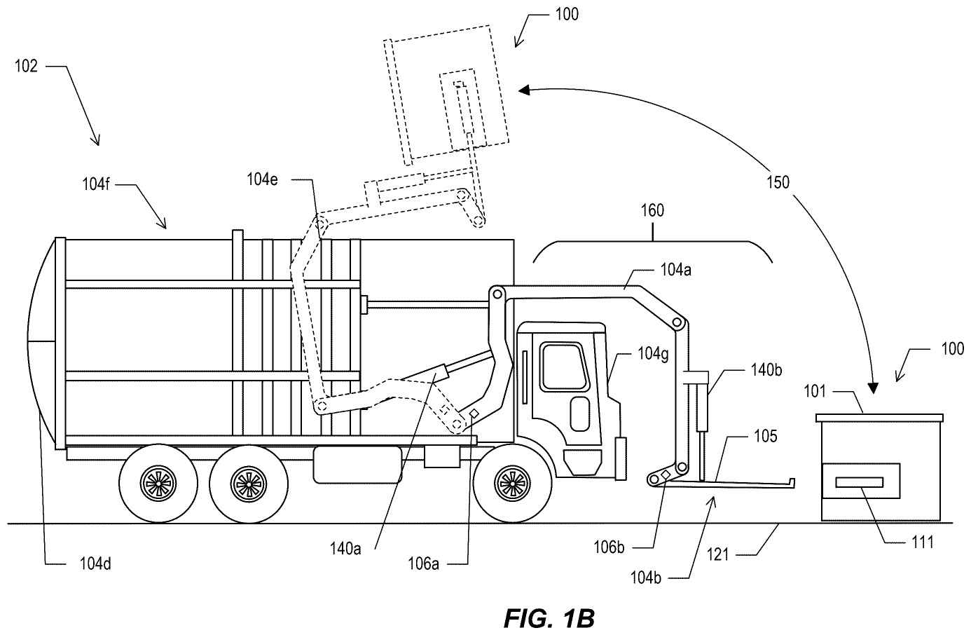

FIG. 1A shows an example system for emptying refuse containers into a refuse collection vehicle 102 by agitating (shaking) the refuse containers to release refuse stuck inside refuse containers. FIG. 1B shows an example schematic of the refuse collection vehicle 102 of FIG. 1A. The vehicle 102 can include any suitable number of vehicle components 104. The vehicle 102 can be a refuse collection vehicle that operates to collect and transport refuse (e.g., garbage). The refuse collection vehicle can also be described as a garbage collection vehicle, or garbage truck. The vehicle 102 can be configured to lift containers 100 that contain refuse, and empty the refuse in the containers into a hopper of the vehicle 102, and/or a Curotto-Can™ conveyed by the refuse collection vehicle, to enable transport of the refuse to a collection site, compacting of the refuse, and/or other refuse handling activities. The vehicle 102 can also handle containers in other ways, such as by transporting the containers to another site for emptying.

As used herein, a vehicle component describes a component of the vehicle that is not directly involved in causing the translational movement of the vehicle from one location to another. For example, a vehicle component can be a lifting component (e.g., pair of lift arms 104a) that operates to lift a refuse container and/or empty the refuse held by the refuse container into a hopper of the refuse collection vehicle or other receptacle. Other types of vehicle components are described below.

The vehicle components 104 can include various components that are appropriate for the particular type of vehicle 102. For example, a garbage collection vehicle may be a truck with an automated side loader (ASL). Alternatively, the vehicle may be a front-loading truck, a rear loading truck, a roll off truck, or some other type of garbage collection vehicle. A vehicle with an ASL may include vehicle components involved in the operation of the ASL, such as arms and/or a fork assembly, as well as other vehicle components such as a pump, a tailgate, a packer, and so forth. The vehicle components are supported by a wheeled chassis. A front-loading vehicle, such as the example shown in FIGS. 1A-1B, may include vehicle components such as a pump, tailgate, packer, grabber, and so forth. A rear loading vehicle may include vehicle components such as a pump, blade, tipper, and so forth. A roll off vehicle may include vehicle components such as a pump, hoist, cable, and so forth. Vehicle components may also include other types of components that operate to bring garbage into a hopper (or other storage area) of a truck, compress and/or arrange the garbage in the hopper, and/or expel the garbage from the hopper.

The vehicle components 104 can include a back gate or tailgate 104d, and a hopper 104e to receive refuse collected from a refuse container. The hopper 104e forms a portion of a storage body 104f of the vehicle 102 that is configured to hold refuse during its transport. The vehicle components 104 can include a cab 104g in which one or more operators resides during operation of the vehicle 102.

As shown in the example of FIG. 1B, the vehicle 102 vehicle components 104 according to the design and/or purpose of the vehicle 102. For example, a vehicle 102 can include vehicle components 104 including a lift arm assembly 160 configured to lift and lower refuse containers. The lift arm assembly 160 includes a pair of lift arms 104a, a pair of corresponding arm cylinders 140a, a fork assembly 104b, and fork cylinders 140b. The fork assembly 104b includes a pair of forks 105 and each fork 105 is coupled to a respective lift arm of the pair of lift arms 104a. FIG. 1B shows a right side of the vehicle 102, with only one lift arm 104a, arm cylinder 140a, fork 105, and fork cylinder 140b shown. Although not shown, the vehicle 102 includes a second lift arm 104a, a second arm cylinder 140a, a second fork 105, and a second fork cylinder 140b on the left side of the vehicle 102.

The pair of lift arms 104a and the fork assembly 104b are operable to raise and lower the container 100 along the path 150, and to rotate the container 100 between inverted positions and non-inverted positions. An inverted position is a position in which refuse in the container 100 can exit an opening 101 at the top of the container 100 due to gravity. A non-inverted position is a position in which refuse in the container 100 cannot exit the opening 101 at the top of the container 100 due to gravity.

During container-emptying operations, the forks 105 of the fork assembly 104b enters corresponding fork pockets 111 of the container 100. For example, the operator of the vehicle 102 can drive the vehicle 102 forward to insert the forks 105 of the fork assembly 104b into the corresponding fork pockets 111 of the refuse container 100. The lift arms 104a lift the fork assembly 104b and the container 100 through a lift cycle along the path 150 from ground 121 to a position above the hopper 104e. During the lift cycle, the fork assembly 104b rotates to maintain the container 100 at a non-inverted position in order to prevent spilling. Near or at the top of the path 150, the fork assembly 104b rotates to invert the container 100 to empty refuse from the container 100 into the hopper 104e. After emptying the container 100 into the hopper 104e, the fork assembly 104b rotates the container 100 to return the container 100 to a non-inverted position, and the pair of lift arms 104a lower to return the fork assembly 104b, and thus the container 100, to the bottom of the path 150. The container 100 is then released from the fork assembly 104b. For example, the operator of the vehicle 102 can drive the vehicle 102 in reverse to disengage the forks 105 of the fork assembly 104b from the fork pocket 111.

The vehicle components 104 can be operated to agitate the refuse container 100 in order to dislodge refuse from the refuse container 100. Agitation of the container 100 can include movement of the lift arms 104a, the fork assembly 104b, or both. In some examples, an agitation of the container 100 includes operating one or more actuators 140 to rotate the fork assembly 104b about a connection point between the fork assembly 104b and the lift arms 104a. In some examples, an agitation of the refuse container includes operating one or more actuators 140 to move the pair of lift arms 104a about a connection point between the pair of lift arms 104a and the vehicle 102. As described above, in some examples, the actuators 140 are cylinders such as hydraulic cylinders (e.g., lift arm cylinder 140a and fork cylinder 140b).

In some examples, an agitation of the refuse container includes rotating the container 100 by moving the fork assembly 104b. For example, after inverting the container 100 to dump refuse into the hopper 104e, the fork assembly 104b can pivot to rotate the container 100 towards a non-inverted position, and then rotate again to return the container 100 to the inverted position.

In some examples, an agitation of the refuse container includes moving the container 100 along the path 150 of the lifting cycle. For example, after lifting the container 100 above the hopper along the path 150, the lift arms 104a can partially lower the container 100 along the path 150, and then raise the container 100 along the path 150 again.

In some examples, agitation of the refuse container includes rotating the container 100 by moving the fork assembly 104b while simultaneously moving the container 100 along the path 150 by moving the lift arms 104a. For example, the container 100 can be partially lowered along the path 150 while being rotated towards a non-inverted position. The container 100 can then be raised along the path 150 while being rotated towards an inverted position. The lifting motion of the lift arms 104a combined with the rotational motion of the fork assembly 104b can help dislodge refuse from the container 100 into the hopper 104e.

An event in which the container is lowered, raised, and/or rotated to agitate the container in an attempt to dislodge refuse from the container 100 can be referred to as a “shake.” In some examples, agitation includes multiple “shakes.”

The arm cylinders 140a are actuators that move the pair of lift arms 104a. The fork cylinders 140b are actuators that move the fork assembly 104b. The arm cylinders 140a, the fork cylinders 140b, or both, can be hydraulic cylinders. Hydraulic cylinders are actuation devices that use pressurized hydraulic fluid to produce linear motion and force. A hydraulic cylinder includes a cylinder rod that retracts or extends through a cylinder chamber due to forces of hydraulic fluid. The distance traveled by the cylinder rod through the cylinder chamber is a stroke. The hydraulic fluid enters and exits the cylinder chamber through ports. Flow rates of the hydraulic fluid entering and exiting the cylinder chamber through the ports can be controlled by flow control valves.

In some examples, the flow control valves are electronically controlled. For example, a flow control valve can receive an electronic control signal (e.g., agitation control signal 142) that causes the flow control valve to open (e.g., to increase flow rate through the valve), or to close (e.g., to decrease flow rate through the valve). The flow control valves can be proportionally controlled such that the flow control valves can be adjusted to a fully closed position, to a fully open position, and to any position between fully open and fully closed.

A hydraulic cylinder can be operated with a cylinder cushion function that adjusts a rate of opening and/or closing of flow control valves. When a cylinder cushion function is enabled, the cylinder cushion function decelerates the cylinder rod near the end of a stroke by restricting the flow rate of hydraulic fluid leaving the cylinder chamber. For example, as the cylinder rod approaches the end of the stroke, a flow control valve can be electronically controlled to close, thereby decreasing the flow rate through the valve, decreasing the rate at which hydraulic fluid exits the cylinder chamber, and reducing the speed of the cylinder rod moving through the chamber.

Decelerating the cylinder rod near end-of-stroke through use of a cylinder cushion stops the rod from striking the mechanical limits of the hydraulic cylinder, preventing mechanical shock. The cylinder cushion function can therefore reduce wear on the cylinder and can reduce the likelihood of mechanical damage to the cylinder and the cylinder rod.

In some examples, the cylinder cushion function can be gradually adjusted through proportional control of the flow control valves. For example, the cylinder cushion function can be increased gradually up to a maximum cushioning level that causes maximum deceleration of the cylinder rod, and can be decreased gradually down to a minimum cushioning level that causes minimum deceleration, or no deceleration, of the cylinder rod.

In some implementations, a mechanical structure can be used to cushion the hydraulic cylinder to prevent the rod from striking the mechanical limits of the hydraulic cylinder. Example mechanical hydraulic cylinder cushions include, but are not limited to, an elastomeric bumper or a hydraulic bumper, such as a spring holding a piston with small holes in it that blocks the flow at the end of the stroke.

When the cylinder cushion function of the lift arm cylinder 140a is on, movement of the pair of lift arms 104a slows when the pair of lift arms 104a approaches an end of the lift cycle. For example, when the container 100 reaches the top of the path 150 or the bottom of the path 150, the lift arm movement will decelerate due to the cylinder cushion function, thereby slowing the movement of the container 100. Similarly, when the cylinder cushion function of the fork cylinder 140b is on, rotation of the fork will decelerate when the fork cylinder 140b reaches an end of the stroke. This can reduce the rate of rotation of the container 100 when the container 100 is rotated to an inverted or non-inverted position, which reduces wear on the lift arms 104a and fork assembly 104b.

In some examples, agitation of the refuse container includes turning off a cylinder cushion function of one or more hydraulic cylinders. For example, agitation can include turning off the cylinder cushion function of a hydraulic cylinder (e.g., the lift arm cylinder 140a, the fork cylinder 140b) in order to prevent deceleration of the respective cylinder rod, and thereby enable agitation of the refuse container. After completion of the agitation of the refuse container, the cylinder cushion function can be turned on again.

In some examples, agitation of the refuse container includes automatically turning off the cylinder cushion function. For example, based on vehicle sensor data 110, temperature data 138, and/or image data 128 received by the onboard computing device 112, the onboard computing device 112 can send an agitation control signal 142 that causes the cylinder cushion function for the actuator 140 to automatically turn off. The actuator 140 can then perform a first agitation of the refuse container 100, either automatically or through operator action. After the first agitation is performed, the onboard computing device 112 may determine that refuse remains in the container 100 based on updated vehicle sensor data 110, temperature data 138, and/or image data 128 received by the onboard computing device 112. In response to determining that refuse remains in the container 100, the onboard computing device 112 can send another agitation control signal 142 that causes the cylinder cushion function to remain off, enabling the actuator 140 to perform a second agitation.

In some examples, the cylinder cushion function can be progressively increased to a higher cushioning level or decreased to a lower cushioning level to control the velocity and/or distance of the agitation. For example, the onboard computing device 112 can send an agitation control signal 142 that causes the cylinder cushion function for the actuator 140 to automatically reduce from a higher cushioning level that permits a lower velocity and/or smaller distance agitation, to a lower cushioning level that permits a higher velocity and/or greater distance agitation.

The cylinder cushion function can be selectively turned off or reduced when refuse container agitation is needed, and can remain on when refuse container agitation is not needed. This can reduce wear on the cylinders by selectively turning off the cylinder cushion function or decreasing the cushioning level only when necessary to dislodge refuse from the container 100.

In some examples, the vehicle 102 includes a top door (not shown) that covers the top of the hopper 104e. In some examples, the top door can be shut during transport of the vehicle 102, and can be opened when collecting refuse. The top door can open and shut, for example, by sliding or by swinging at a hinge. The top door can be operable by the operator of the vehicle 102 using one or more controls in the cab 104g of the vehicle 102.

In some implementations, vehicle sensors 106 are located at various positions on the vehicle and arranged to generate vehicle sensor data that indicates a current operational state of one or more vehicle components of the vehicle. Vehicle sensors 106 may be arranged in the vehicle components, or in proximity to the vehicle components, to monitor the operations of the vehicle components.

The vehicle sensors 106 may emit signals that include the vehicle sensor data 110 describing the vehicle component operations, and the signals may vary appropriately based on the particular vehicle component being monitored. The vehicle sensor data 110 is output to a control system and/or other computing device, such as an onboard computing device 112 of the vehicle 102. The vehicle sensor data 110 can be analyzed to determine the presence of a triggering condition that is based at least partly on the state or position of at least one vehicle component, such as the lifting component being at a particular position in its cycle along the path 150 to lift and empty a refuse container into the hopper of the vehicle. Triggering conditions can also be based on other factors, such as the speed, deceleration, and/or location of the vehicle.

In the example of FIG. 1B, the lift arm assembly 160 includes a lift arm sensor 106a that is arranged to detect the position of the arm 104a, such as during its cycle to lift a container 100 along a lift path 150 to unload the container 100 into the hopper 104e.

In some implementations, the vehicle 102 includes a fork assembly sensor 106b that is arranged to detect the rotational position of the fork assembly 104b relative to the pair of lift arms 104a.

In some examples, the vehicle sensors 106 include weight sensors configured to measure a weight of the container 100. The weight sensors can generate vehicle sensor data 110 indicating the weight of the container 100.

In some examples, the vehicle sensor 106 includes pressure sensors configured to measure hydraulic pressure of actuators of the vehicle 102 (e.g., arm cylinder 140a, the fork cylinder, or both). The pressure sensors can generate vehicle sensor data 110 indicating hydraulic pressure of the arm cylinder 140a and the fork cylinder 140b. The vehicle sensor data 110 generated by the pressure sensors can be analyzed to estimate a weight of the container 100.

In some examples, the weight of the container 100 can be used to determine an amount (e.g., volume, weight, mass) of refuse in the container 100. In some examples, the weight of the container 100 can be used to determine a likelihood that refuse remains in the container 100 after the container 100 is lifted above the hopper 104e. In some examples, the weight of the container 100 after unloading refuse from the container 100 into the hopper 104e can be compared to the weight of the container 100 before unloading the refuse from the container 100 into the hopper 104e. An estimated amount of the remaining refuse in the container 100 can be determined based on the comparison. The estimated amount can be, for example, an estimated number of cubic meters, cubic feet, liters, gallons, pounds, tons, or kilograms of refuse.

In some implementations, one or more cameras 130 can be mounted on the vehicle 102 or otherwise present on or in the vehicle 102. The camera(s) 130 can each generate image data 128 that includes one or more images of a scene external to and in proximity to the vehicle 102 and/or image(s) of an interior of the vehicle 102. The image data 128 is output to a control system and/or other computing device, such as an onboard computing device 112 of the vehicle 102.

The onboard computing device 112 can analyze the image data 128 to determine whether agitation of the refuse container 100 is recommended to dislodge refuse from the container 100. In some implementations, the determining of whether agitation of the refuse container 100 is based on detecting that refuse remains inside the refuse container 100 after inverting the container 100 over the opening of the hopper 104e, as determined based on the image data 128. In some implementations, the determination of whether agitation of the refuse container is recommended is based at least in part on an amount of refuse that remains in the container 100 after inverting the container 100 over the opening of the hopper 104e, as determined using the image data 128. For example, agitation of the refuse container may be more likely to be recommended when a greater amount of refuse remains in the container 100 than when a smaller amount of refuse remains in the container 100.

The camera(s) 130 can be mounted to capture image(s) of the container 100 before, during, and/or after the unloading the container 100 into the hopper of the vehicle, a Curotto-Can™, and/or other receptacle. In some implementations, one or more cameras 130 are arranged to capture image(s) of a container 100 before, after, and/or during the operations of vehicle components 104 to empty the container 100 into the hopper of the vehicle 102. In some examples, for a front-loading vehicle, the camera(s) 130 can be arranged to capture images of objects in front of the vehicle. As another example, for a side loading vehicle, the camera(s) 130 can be arranged to capture images of objects to the side of the vehicle, such as a side that mounts the ASL to lift containers.

In some examples, the camera(s) 130 capture images continuously or at designated intervals. In some examples, the camera(s) 130 capture video images. In some implementations, capturing images by the camera(s) 130 is performed in response to detecting a triggering condition, such as a pair of lift arms 104a being in a particular position in its cycle along the path 150 to empty a container into the hopper of the vehicle. In some implementations, the image(s) of the container 100 are generated while the container 100 is in a substantially stationary state, such as after it has been emptied into or onto some component of the refuse collection vehicle. For example, the image(s) can be taken of the container after it has been emptied into a hopper of the refuse collection vehicle, such that a set of image(s) is taken of the recently emptied container after each instance when a refuse container has been emptied into the hopper (e.g., after each instance of service a refuse collection customer).

As described herein, the triggering condition can be one or more of the following: a particular operational state of a vehicle component (e.g., a position of the pair of lift arms 104a in its cycle as detected by lift arm sensor 106a and/or a position of the fork assembly 104b as detected by fork assembly sensor 106, vehicle sensor data 110, temperature data 138, and/or image data 128 received by the onboard computing device 112b), a velocity (e.g., speed and/or direction of travel) of the vehicle, an acceleration or deceleration of the vehicle, a location of the vehicle, an environmental temperature at the location of the vehicle (e.g., as detected by temperature sensor 132), and/or other criteria. The presence of the triggering condition can cause the collection and/or analysis of the image data to determine container volume and/or determine whether agitation of the refuse container is recommended.

Although examples herein may describe analyzing image(s) in the visible light spectrum to identify a degree of emptiness of the refuse container 100, implementations are not so limited. Implementations can also employ other ranges of the electromagnetic spectrum to estimate the amount of refuse in the refuse container 100, such as through analysis of images that capture emissions in the infrared, microwave, or ultraviolet (UV) ranges. Implementations can also employ other types of cameras to detect the refuse in a container and to estimate the amount of refuse in the container, such as radar or ultrasound probing. The imaging of the container can be passive, such as capturing image(s) of the container using camera(s). The imaging of the refuse can also be active, such as through using electromagnetic, sonic, or other types of probing to send a signal toward the refuse and detect any signal(s) reflected back from the refuse.

The image generation devices (e.g., cameras) and/or other camera devices can include, but are not limited to, one or more of the following: visible spectrum cameras, thermal (e.g., infrared) cameras, temperature sensors, infrared sensors, UV sensors, ultrasonic (ultrasound) sensors, Doppler-based sensors, time-of-flight (TOF) sensors, color sensors (e.g., for determining, RGB data, XYZ data, etc., with or without infrared channel blocking), microwave radiation sensors, x-ray radiation sensors, radar, laser-based sensors, LIDAR-based sensors, thermal-based sensors, spectral cameras (e.g., including hyper-and/or ultra-spectral imaging technology that use spectral fingerprints to classify very small objects at high speeds), and so forth.

In some implementations, the image(s) and/or other image data can be captured while the refuse is stationary in a Curotto-Can™. Moreover, the image(s) and/or other image data can be captured while the refuse is falling into the Curotto-Can™, or into some other structure that is being conveyed by the refuse collection vehicle but that is not an attached component of the refuse collection vehicle, which as while the pair of lift arms 104a of the refuse collection vehicle is operating to empty a container into the Curotto-Can™ that is being conveyed by the refuse collection vehicle.

Different types of image data can be combined to create the sensor fusion, to provide greater confidence in the predictions through analysis of different types of data. A sensor fusion is a combination of different sensor data types. A sensor fusion can be a time-based correlation of different types of data. For example, infrared data at a particular time can be correlated with image and/or video data at the same time, as well as potentially other types of data.

In some implementations, the hopper, Curotto-Can™, or other container that holds the refuse can be arranged with source(s) of illumination. For example, strips of light, point sources of light, lamps, LED fixtures, and/or other suitable light sources can be used to illuminate the refuse to enable the collection of image data that is more effectively analyzed for a higher confidence prediction. Any suitable number and arrangement of light sources can be employed. The light source(s) can be arranged to provide substantially uniform illumination of an interior of the container (e.g., in white light). The light source(s) can emit visible light and/or light in other spectrum ranges, such as infrared or UV illumination of the container. In some examples, the light source is controllable to turn on to illuminate the refuse in response to detection of a service event. The service event can be detected using, for example, a particular operational state of a vehicle component (e.g., a position of the pair of lift arms 104a in its cycle as detected by lift arm sensor 106a and/or a position of the fork assembly 104b as detected by fork assembly sensor 106, vehicle sensor data 110, temperature data 138, and/or image data 128 received by the onboard computing device 112b), a velocity (e.g., speed and/or direction of travel) of the vehicle, an acceleration or deceleration of the vehicle, a location of the vehicle, an environmental temperature at the location of the vehicle (e.g., as detected by temperature sensor 132), and/or other criteria. The light source can be controllable to turn off in response to detecting completion of the service event.

In some examples, the vehicle 102 includes a temperature sensor 132 that senses temperature at the location of the vehicle. For example, the temperature sensor 132 can be a thermometer that measures temperature external to the vehicle 102. The temperature sensor 132 outputs temperature data 138 to a control system and/or other computing device, such as an onboard computing device 112 of the vehicle 102. In some examples, in addition to or instead of receiving temperature data 138 from the temperature sensor 132, the onboard computing device 112 can receive temperature data from other sources. For example, the onboard computing device 112 can receive temperature data from an internet data source.

In some implementations, the determination of whether agitation of the refuse container 100 is recommended is based at least in part on the environmental temperature at the location of the vehicle 102 (e.g., as detected by the temperature sensor 132). In some implementations, agitation of the refuse container 100 is more likely to be recommended at lower temperatures than at higher temperatures. This is due to colder temperatures being more likely to cause refuse to freeze to the sides and bottom of the container 100, making it more difficult to release refuse from the container 100.

In some implementations, the vehicle sensor data 110, image data 128, temperature data 138, or any combination thereof may be communicated from the body sensors 106, the temperature sensor 132, and the camera(s) 130, respectively, to an onboard computing device 112 in the vehicle 102. In some instances, the onboard computing device is an under-dash device (UDU), and may also be referred to as the Gateway. Alternatively, the device 112 may be placed in some other suitable location in or on the vehicle. The sensor data and/or image data may be communicated from the sensors and/or camera, to the onboard computing device 112, over a wired connection (e.g., an internal bus) and/or over a wireless connection. In some implementations, a J1939 bus connects the various sensors and/or cameras with the onboard computing device. In some implementations, the sensors 106, 132 and/or cameras 130 may be incorporated into the various vehicle components. Alternatively, the sensors 106, 132 and/or cameras 103 may be separate from the vehicle components. In some implementations, the sensors 106, 132 and/or cameras 130 digitize the signals that communicate the sensor data and/or image data, before sending the signals to the onboard computing device if the signals are not already in a digital format.

The onboard computing device 112 can include one or more processors 114 that provide computing capacity, data storage 116 of any suitable size and format, and network interface controller(s) 118 that facilitate communication of the device 112 with other device(s) over one or more wired or wireless networks.

In some implementations, the analysis of the vehicle sensor data 110, image data 128, temperature data 138, or any combination thereof is performed at least partly by the onboard computing device 112, e.g., by processes that execute on the processor(s) 114. For example, the onboard computing device 112 may execute processes that perform an analysis of the vehicle sensor data 110 to detect the presence of a triggering condition, such as a pair of lift arms 104a being in a particular position in its cycle along the path 150 to empty a container into the hopper of the vehicle.

In some instances, a triggering condition may also be based at least partly on a location of the vehicle 102, as determined through a satellite-based navigation system, such as the global positioning system (GPS), or through other techniques. In such instances, the onboard computing device 112 can include location sensor device(s) 148, such as GPS receivers or other types of sensors that enable location determination. The location sensor(s) can generate location data that describes a current location of the vehicle 102 at one or more times. The location data can be used, alone or in conjunction with the vehicle sensor data 110, to determine the presence of a triggering condition. For example, a triggering condition can be present when the location of the vehicle 102 is at, or within a threshold distance of, a previously determined and stored location of a container 100 to be emptied. Accordingly, the location data and sensor data can be analyzed, on the device 112, to determine the presence of a triggering condition. The data analysis of the vehicle sensor data 110, image data 128, temperature data 138, or any combination of these, on the device 112 or elsewhere, may be performed in real time with respect to the generation of the sensor data, image data, temperature data, and/or location data. In some examples, the vehicle sensor data 110, image data 128, and/or temperature data 138 analyzed may include those image(s) and/or sensor data captured at a time that is a predetermined offset from the triggering condition, such as two seconds after the completion of a cycle to empty a container in the hopper and/or Curotto-Can™ of a refuse collection vehicle.

In some implementations, the vehicle sensor data 110 can be used in correlation with location data to determine the presence of a triggering condition that determines a time period for the image data 128 generated by the camera(s) 130 to be analyzed. For example, the detection of a pair of lift arms 104a completing its cycle, in conjunction with a determination that the current GPS location of the vehicle corresponds to a known location of a container that is serviced, can be used as a triggering condition to identify one or more images and/or other image data 128 to be analyzed in order to determine whether agitation of a refuse container 100 being serviced by the vehicle 102 is recommended. Image(s) and/or other image data can be generated with a timestamp indicating the date and/or time when they were captured. The image(s) and/or other image data can also include metadata describing which camera (e.g., camera and/or other sensor) generated the data. The timestamp and/or other metadata can be used to determine which image(s) and/or other image data are to be analyzed to estimate an amount of refuse remaining inside the container 100.

In some implementations, the analysis of the image and/or sensor data to determine whether agitation of the refuse container is recommended to dislodge refuse from the container 100 is performed at least partly on the onboard computing device 112, operating for example as an edge device. For example, the device 112 may include a processor with a central processing unit (CPU), a digital signal processor (DSP), a graphics processing unit (GPU), and/or a neural network processing unit that operate to analyze the image and/or sensor data on the device 112.

In some examples, the onboard computing device 112 includes an analysis module 122. The analysis module can analyze the data 110, 128, 138 to determine whether agitation of the refuse container is recommended to dislodge refuse from the container 100. Such analysis can include analyzing the image data 128 to determine a degree of emptiness of the container 100, and based on the degree of emptiness, determining whether agitation of the refuse container 100 is recommended.

In some implementations, the analysis module 122 includes a machine learning (ML) engine 136, which can also be described as a classifier, a model, an image classifier, or an image classification engine. The ML engine 136 can include a container analysis model that is trained to analyze images of refuse containers. For example, the ML engine 136 can be trained, using any suitable ML technique, to determine a degree of emptiness of the container 100 and to determine whether agitation of the refuse container is recommended to dislodge refuse from the container 100.

In some examples, the ML engine 136 can be trained to look for various patterns and/or features within image data 128, temperature data 138, and/or vehicle sensor data 110 that indicate whether refuse is present in the container 100, a degree of fullness of the container 100, a degree of emptiness of the container, whether agitation of the refuse container 100 is recommended, or any combination of these. In some implementations, the ML engine 136 can be trained based on a large data set of image data, temperature data, and/or sensor data that has been tagged as containing refuse or not containing refuse. The training data can be labeled, for example, by an operator reviewing the vehicle sensor data 110, image data 128, temperature data 138, or any combination thereof.

In some implementations, the analysis performed by the ML engine 136 can employ a suitable deep learning network. The network can provide a measure of fit, such as a precision metric. In some implementations, a loss function may be employed, and the level of precision or confidence in the prediction may be based on the loss function being less than a threshold value. For example, the model may be trained until the loss function is less than the threshold value, to ensure an appropriate degree of accuracy (e.g., confidence) in the prediction output by the model. In a particular example, a false positive rate (e.g., of incorrectly identifying the presence of refuse in a container) may be kept at five percent or less.

The onboard computing device 112 can be communicably coupled to the vehicle sensor 106, the camera 130, the temperature sensor 132, or any combination of these. The onboard computing device 112 can also be communicably coupled to the one or more actuators 140 and/or to one or more computing devices 126.

The onboard computing device 112 can provide one or more outputs based on analysis of the vehicle sensor data 110, image data 128, temperature data 138, and/or location data. In some examples, the onboard computing device 112 outputs an agitation control signal 142 to one or more actuators 140. The actuators 140 can include, for example, the arm cylinder 140a and the fork cylinder 140b. The agitation control signal 142 can include an instruction that causes automatic agitation of the container 100 or that causes no agitation of the container 100. For example, in order to cause agitation of the refuse container, the agitation control signal 142 can include an instruction that causes automatic movement of the fork assembly 104b, the pair of lift arms 104a, or both, to agitate the container 100. The agitation control signal 142 can specify parameters of the agitation including, but not limited to, a type, speed, and/or duration of agitation.

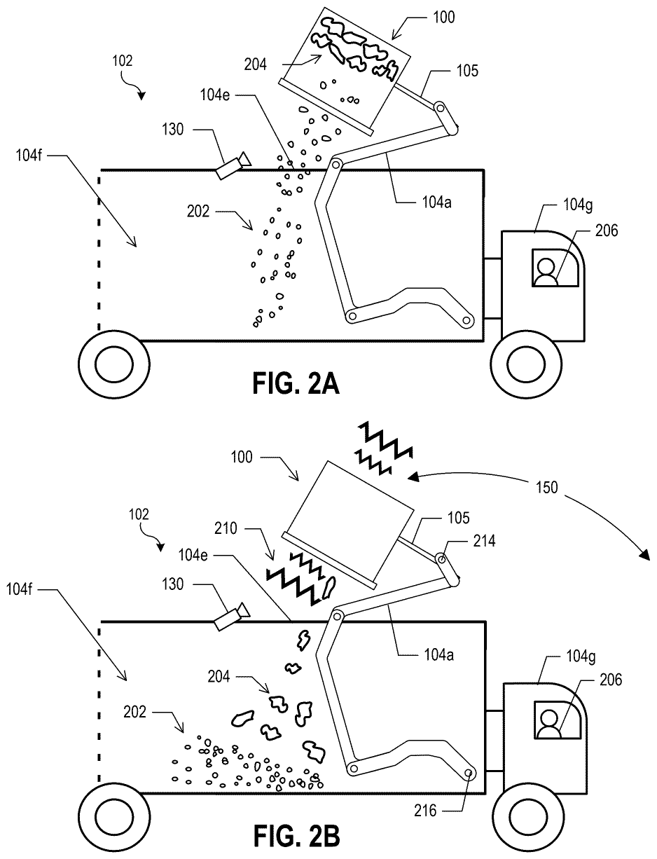

In some examples, in order to cause agitation of the refuse container, the agitation control signal 142 can include an instruction that causes the cylinder cushion function to turn off or to adjust to a reduced cushioning level. The agitation control signal 142 can specify parameters of the cushioning reduction include, but not limited to, a rate of change of the cushioning level, a total amount of cushioning reduction, and/or a duration of cushioning reduction. Operations that cause agitation of the container 100 are described in greater detail with reference to FIGS. 2A and 2B.

To prevent additional agitation of the refuse container, the agitation control signal 142 can include an instruction that prevents agitating movement of the fork assembly 104b, the pair of lift arms 104a, or both. In some examples, the agitation control signal 142 includes an instruction that causes the fork assembly 104b and the pair of lift arms 104a to lower the container 100 to the ground 121 without agitating the container 100.

In some examples, in order to prevent additional agitation of the refuse container, the agitation control signal 142 can include an instruction that turns the cylinder cushion function on after the cylinder cushion function has been turned off, or that increases the cushioning level of the cylinder cushion function after the cushioning level of the cylinder cushion function has been reduced.

In some examples, the agitation control signal 142 cannot be overridden by manual control. For example, the vehicle 102 can include a joystick or other controller in the cab of the vehicle 102 that controls movement of the pair of lift arms 104a and fork assembly 104b. The agitation control signal 142 can permit the joystick to control movement of the pair of lift arms 104a and fork assembly 104b to lower the container 100 to the ground 121, while prohibiting the joystick from moving the pair of lift arms 104a and fork assembly 104b to agitate the container 100.

In some examples, the agitation control signal 142 can be overridden by manual control. For example, the agitation control signal 142 can cause the pair of lift arms 104a and the fork assembly 104b to lower the container 100 to the ground 121, unless input is received from the joystick to perform other actions such as raising the container 100, holding the container 100 steady, and/or agitating the container 100.

In some examples, the onboard computing device 112 outputs an agitation notification 144 to a computing device 126. The computing device 126, can be, for example, a computing device in the cab 104g of the vehicle 102. The agitation notification 144 can include a visual notification presented on a display, a light illuminated inside the cab 104g, an audible notification broadcast inside the cab 104g, or any combination of these.

The agitation notification 144 can include a message recommending whether to agitate the container 100. In some examples, the agitation notification 144 includes a message indicating that the cylinder cushion function has been turned off or reduced to a lower cushioning level. After receiving the agitation notification 144, the operator can operate the pair of lift arms 104a and fork assembly 104b using manual controls in the cab 104g. For example, the agitation notification 144 may include a message recommending to agitate the container 100. In some examples, the agitation notification 144 can recommend agitation parameters. For example, the recommendation can include a recommended type, speed, and/or duration of agitation. For example, the agitation notification 144 can include a recommendation of a number of seconds that the container 100 should be agitated and/or a number of times that the container 100 should be rotated to right-side-up and then inverted to upside-down.

After receiving the agitation notification 144, the operator can use the joystick to move the pair of lift arms 104a and/or fork assembly 104b to agitate the container 100 according to the recommendation. In some cases, the operator may choose not to agitate the container 100, contrary to the recommendation to agitate the container 100. For example, the vehicle 102 may be located in a high traffic location, and the operator may choose to lower the container 100 to the ground 121 without agitating the container 100, in order to reduce the amount of time spent in the high traffic location.

In some examples, the agitation notification 144 includes a message recommending not to agitate the container 100. After receiving the agitation notification 144, the operator can use the joystick to lower the container 100 to the ground 121 without agitating the container 100 according to the recommendation. In some cases, the operator may choose to agitate the container 100, contrary to the recommendation to not agitate the container 100. For example, the vehicle 102 the operator may observe refuse stuck to the container 100 that is not visible to the camera 130 (e.g., refuse stuck to the bottom of the container 100), and may choose to agitate the container 100 in order to dislodge the stuck refuse. In some cases, entry of a password or passcode is required in order to agitate the container 100 when agitation is not recommended. For example, the operator can enter a password that enables access to control of the cylinder cushion function of the actuators 140. The operator can then turn the cylinder cushion function off or to a reduced cushioning level, and can operate the pair of lift arms 104a and fork assembly 104b to agitate the container. In some examples, the cylinder cushion function automatically returns to its previous setting (e.g., “on” or at a higher cushioning level) a specified time duration after turning the cylinder cushion function off or after reducing the cushioning level.

In some examples, the agitation notification 144 includes a message indicating whether an agitation control signal 142 will be output, or has been output, to the actuators 140. For example, the agitation notification 144 can include a message stating that the container 100 will be agitated or is being agitated. The agitation notification 144 can include information about the agitation parameters specified by the agitation control signal 142.

In some examples, the agitation notification 144 includes a message stating that the cylinder cushion function is turned off or set to a reduced cushioning level. The agitation notification can include information about the parameters of the cushioning reduction specified by the agitation control signal 142.

Implementations may be employed with respect to any suitable type of refuse collection vehicle, with any suitable type of body and/or hopper variants. For example, the refuse collection vehicle may be an automated side loader vehicle, with cameras and/or other cameras at the hopper opening.

As another example, the refuse collection vehicle can be a residential front loader (e.g., with or without a Curotto-Can™ can), with cameras and/or other sensors at hopper opening and/or at the front of the body (e.g., above the bumper) to view into the Curotto-Can™. Cameras and/or other sensors can also be located in the Curotto-Can™ itself. In such instances, weight sensors can be located on the arm of the Curotto-Can™ and/or on the pair of lift arms 104a as attached to the Curotto-Can™, to detect changes in weight of carried refuse and determine possible volume based on weight. As another example, the refuse collection vehicle can be a rear loader, with cameras and/or other sensors embedded in an acrylic strip or other suitable component (e.g., across the floor of the rear hopper).

In some instances, the emptying of a refuse container by a refuse collection vehicle includes emptying the refuse container into a receptacle that is being transported by the refuse collection vehicle but that is not a permanently attached component of the refuse collection vehicle, instead of being emptied into a hopper of the refuse collection vehicle. Examples of such a receptacle can include, but are not limited to, a Curotto-Can™ (e.g., carried by a front arm of the refuse collection vehicle) and a carry can (e.g., carried by a Bayne Lifter or other mechanism on the side of the refuse collection vehicle). The receptacle can be an automated can, such as a Curotto-Can™, or a semi-automated can, such as a carry can with tipper mechanism. In some implementations, the image(s) of the container are generated while the refuse is falling into the collection receptacle that is being transported by the refuse collection vehicle but that is not a component of the refuse collection vehicle itself.

FIG. 2A shows an example refuse collection vehicle 102 and refuse container 100 prior to agitation 210 of the refuse container 100. The vehicle 102 includes a camera 130 that is positioned with a view towards an opening of the hopper 104e. In some implementations, the camera 130 is coupled to the refuse collection vehicle 102 proximate a rear portion of the hopper 104e. When the container 100 is lifted over the hopper 104e, the interior of the container 100 is within the field of view of the camera 130. Any suitable number of cameras and/or other sensors can be employed. A combination of cameras and/or sensors may monitor the container as refuse from the container are being dumped into the hopper 104e.

In the example of FIG. 2A, a first volume 202 of refuse falls out of the container 100 when the container 100 is lifted and inverted by the pair of lift arms 104a and the fork assembly 104b. A second volume 204 of refuse remains inside the container 100 after the container 100 is initially inverted by the pair of lift arms 104a and fork assembly 104b.

The second volume 204 of refuse may remain inside the container 100 for a number of reasons. For example, the second volume 204 can include refuse that have been compacted at the bottom and/or sides of the container 100, and therefore do not fall freely out of the container 100 when the container 100 is initially lifted and inverted over the hopper 104e. In some cases, the second volume 204 includes refuse that have frozen to the bottom and/or sides of the container 100. In some cases, the second volume 204 includes refuse that is stuck to the bottom and/or sides of the container 100 due to the presence of water and/or other liquids inside the container 100. The second volume 204 can also include refuse that is caught on an edge of the container 100, refuse that is blocked from exiting the container 100 by another piece of refuse, refuse that is trapped behind a lid of the container that is stuck shut or not fully open, and expandable refuse that is stuck due to the refuse pressing against walls of the container 100.

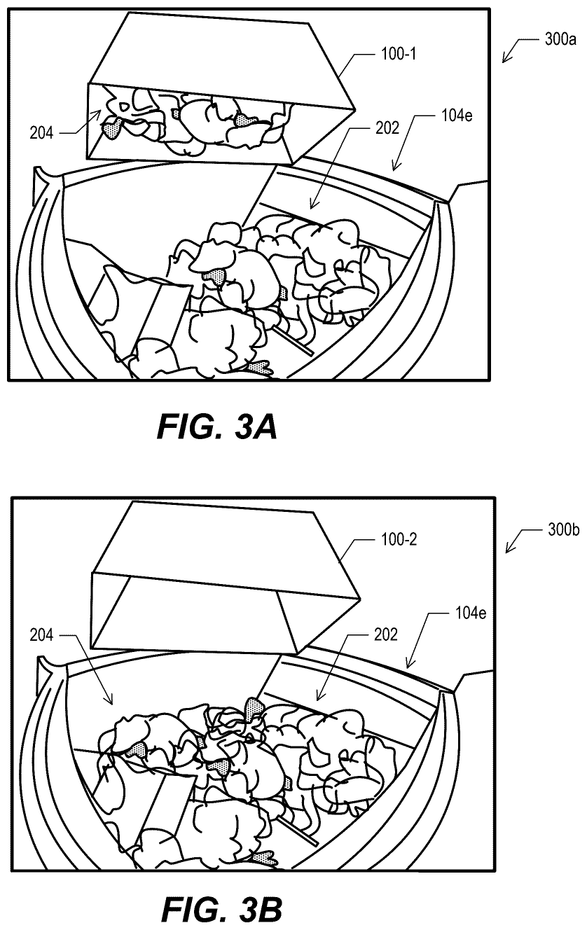

The camera 130 captures images of the container 100 as it is inverted over the hopper 104e. FIG. 3A shows an example camera image 300a of the non-empty refuse container 100 above the hopper 104e of the vehicle 102. The image 300a is captured by the camera 130, which is positioned at a front corner of a top opening of the hopper 104e. The image 300a shows the second volume 204 of refuse remaining inside the container 100 after initially inverting the container 100 over the hopper 104e, with the first volume 202 of refuse being in the hopper 104e. The interior of the container 100 still contains the second volume 204 of refuse because the second volume 204 of refuse is stuck in the container 100.

The onboard computing device 112 or another computing device, can analyze the camera images (e.g., image 300a) to determine whether agitation of the container 100 is recommended to dislodge refuse from the container 100. In the examples of FIG. 3A, based on processing the image 300a, the onboard computing device 112 recommends agitation of the container 100 due to the second volume 204 of refuse remaining in the container 100.

In some examples, the onboard computing device 112 determines whether to recommend agitation of the container 100 based on an estimated amount of refuse remaining in the container 100. For example, the onboarding computing device 112 may determine that agitation of the container 100 is recommended in response to determining that the amount of refuse remaining in the container 100 satisfies (e.g., exceeds) a threshold amount.

The threshold amount can be, for example, a threshold percentage volume of the container 100. In an example, the threshold amount is ten percent of the volume capacity of the container 100, and in response to determining that the estimated amount of refuse remaining in the container 100 exceeds ten percent of the volume capacity of the container 100, the onboard computing device 112 determines to recommend agitation of the container 100.

In some cases, the threshold amount can be an estimated volume measurement of refuse within the container 100. For example, the threshold amount can be two cubic meters of refuse, and in response to determining that the estimated amount of refuse remaining in the container 100 exceeds two cubic meters of refuse, the onboard computing device 112 can determine to recommend agitation of the container 100.

In some examples, in response to determining that agitation of the refuse container 100 is recommended, the onboard computing device 112 sends an agitation control signal 142 to one or more actuators 140 that cause agitation of the container 100. In some examples, in response to determining that agitation of the refuse container 100 is recommended, the onboard computing device 112 sends a notification of the recommendation to a user, such as an operator 206 of the vehicle 102. The operator 206 can then operate controls in the cab 104g of the vehicle 102 to agitate the container 100.

FIG. 2B shows the example refuse collection vehicle 102 and refuse container 100 during agitation 210 of the refuse container 100. The refuse container 100 is the same as the container 100, at a later time when agitation 210 is occurring.

Agitation 210 of the container 100 can include movement of the pair of lift arms 104a, the fork assembly 104b, or both. In some examples, an agitation 210 of the container 100 includes operating one or more actuators 140 to rotate the fork assembly 104b about a connection point (e.g., connection point 214) between the fork assembly 104b and the pair of lift arms 104a. In some examples, an agitation 210 includes operating one or more actuators 140 to move the pair of lift arms 104a about a connection point (e.g., connection point 216) between the pair of lift arms 104a and the vehicle 102. As described above, in some examples, the actuators 140 are cylinders such as hydraulic cylinders (e.g., lift arm cylinder 140a and fork cylinder 140b).

In some examples, an agitation 210 includes rotating the container 100 by moving the fork assembly 104b. For example, after inverting the container 100 to dump refuse into the hopper 104e, the fork assembly 104b can pivot to rotate the container 100 towards a non-inverted position, and then rotate again to return the container 100 to the inverted position.

In some examples, an agitation 210 of the container 100 includes moving the container 100 along the path 150 of the lifting cycle. For example, after lifting the container 100 above the hopper along the path 150, the lift arms 104a can partially lower the container 100 along the path 150, and then raise the container 100 along the path 150 again.

In some examples, agitation 210 of the container 100 includes rotating the container 100 by moving the fork assembly 104b while simultaneously moving the container 100 along the path 150 by moving the lift arms 104a. For example, the container 100 can be partially lowered along the path 150 while being rotated towards a non-inverted position. The container 100 can then be raised along the path 150 while being rotated towards an inverted position. The lifting motion combined with the rotational motion can help dislodge refuse from the container 100 into the hopper 104e.

An event in which the container is lowered, raised, and/or rotated to agitate the container in an attempt to dislodge refuse from the container 100 can be referred to as a “shake.” In some examples, agitation 210 includes multiple “shakes.”

In some examples, agitation 210 of the container 100 includes turning off a cylinder cushion of one or more hydraulic cylinders. For example, agitation 210 can include turning off the cylinder cushion of a hydraulic cylinder (e.g., the lift arm cylinder 140a, the fork cylinder 140b) in order to prevent deceleration of the cylinder rod, and thereby increase velocity of the agitation. After completion of the agitation 210, the cylinder cushion can be turned on again.

In some examples, agitation 210 of the container 100 includes turning off the cylinder cushion when previous attempts at agitation have been unsuccessful at dislodging the refuse from the container 100. For example, based on vehicle sensor data 110, temperature data 138, and/or image data 128 received by the onboard computing device 112, the onboard computing device 112 can send an agitation control signal 142 that causes the actuator 140 to automatically perform a first shake. After the first shake is performed, the onboard computing device 112 may determine that refuse remain in the container 100 based on updated vehicle sensor data 110, temperature data 138, and/or image data 128 received by the onboard computing device 112. In response to determining that refuse remains in the container 100, the onboard computing device 112 can send another agitation control signal 142 that causes the cylinder cushion to automatically turn off, and causes the actuator 140 to automatically perform a second shake, such that the second shake is at a higher velocity than the first shake. Thus, the cylinder cushion can be selectively turned off when a higher velocity shake is needed, and can remain on when the higher velocity shake is not needed. This can reduce wear on the cylinders by selectively turning off the cylinder cushion only when necessary to dislodge refuse from the container 100.

FIG. 3B shows an example camera image 300b of the empty refuse container 100 above the hopper 104e of the vehicle 102 following agitation of the refuse container 100. The image 300b is captured by the camera 130. The image 300b shows the second volume 204 and the first volume 202 of refuse being in the hopper 104e. The interior of the container 100 no longer contains refuse because the agitation of the container 100 has dislodged all of the refuse, including the second volume 204 of refuse, from the container 100.

The onboard computing device 112 or another computing device, can analyze the camera images (e.g., image 300b) to determine whether agitation of the refuse container 100 is recommended to dislodge refuse from the container 100. In the examples of FIG. 3B, based on processing the image 300b depicting the empty container 100, the onboard computing device 112 recommends no agitation of the container 100 due to the container 100 being empty.

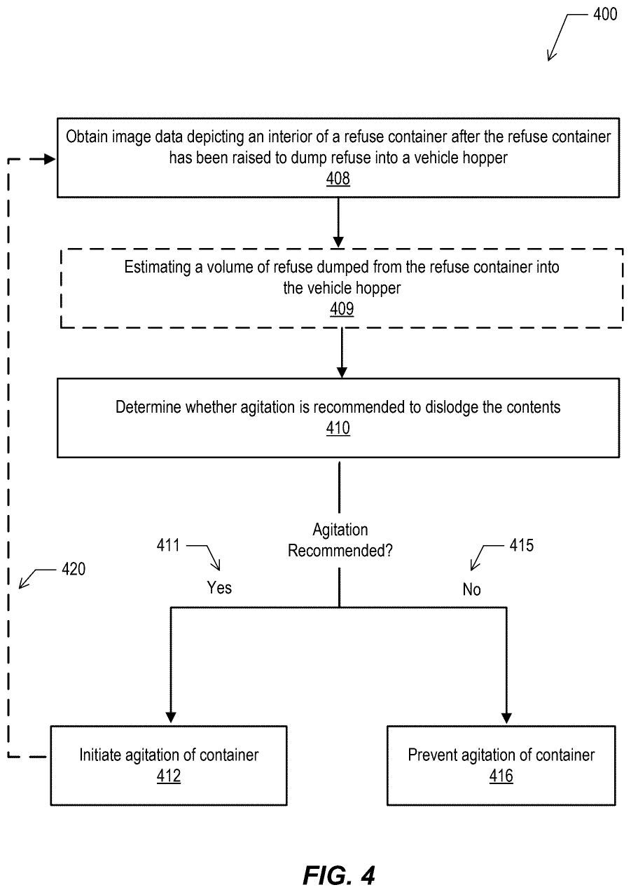

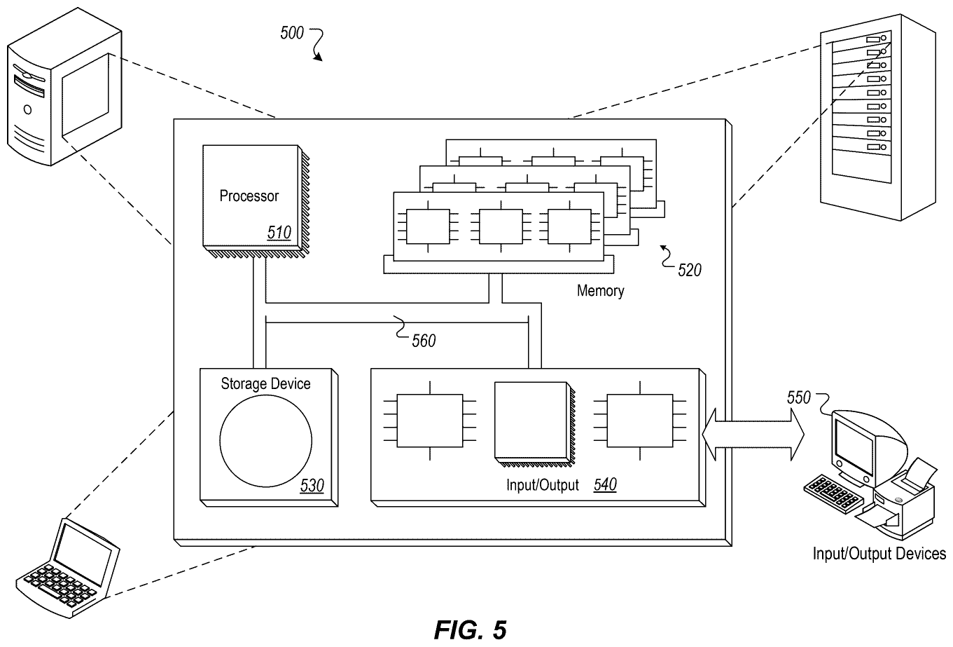

FIG. 4 shows a flow diagram of an example process 400 for emptying containers by agitation according to implementations of the present disclosure. Operations of the process can be performed by one or more of the analysis module 122, the ML engine 136, and/or other software module(s) executing on the onboard computing device 112 and/or elsewhere.

The process 400 includes obtaining image data depicting an interior of a refuse container after the refuse container has been raised to dump refuse into a vehicle hopper (408). For example, the onboard computing device 112 can obtain image data 128 captured by the camera 130 that is mounted to the vehicle 102.

In some examples, the image data 128 is obtained in response to determining that a position of the lift arm assembly 160 satisfies position criteria based on one or more signals received from one or more vehicle sensors 106 (e.g., from lift arm sensor 106a and/or from the fork assembly sensor 106b). The position criteria can include, for example, a minimum height of the pair of lift arms 104a. In some examples, the position criteria includes a minimum rotational position of the container 100. In some examples, the position criteria includes a minimum time duration that the container 100 has been inverted.

The onboard computing device 112 can obtain vehicle sensor data 110 (e.g., from the lift arm sensor 106a) indicating a position of the lift arm assembly 160. The onboard computing device 112 can determine, based on the vehicle sensor data 110, that the position of the pair of lift arms 104a satisfies the position criteria (e.g., is above the minimum height, is past the minimum rotational position, and/or has been inverted for at least the minimum time duration). In response to determining that the position of the pair of lift arms 104a satisfies the position criteria, the onboard computing device 112 can obtain the image data 128 from the camera 130, can analyze the image data 128, or both.

In some examples, the image data 128 is obtained in response to determining that refuse has been added into the hopper 104e. For example, the hopper 104e can include weight sensors and/or other vehicle sensors 106 that detect when refuse is added into the hopper 104e. The onboard computing device 112 can receive vehicle sensor data 110 from the vehicle sensors 106 indicating that refuse has been added to the hopper 104e. In response to determining that refuse has been added into the hopper 104e, the onboard computing device 112 can obtain the image data 128 from the camera 130, can analyze the image data 128, or both. In some examples, in addition to the image data 128, the onboard computing device 112 obtains temperature data 138 from the temperature sensor 132. In some implementations, the camera 130 can be controlled to capture image data 128 in response to a triggering condition. For example, based on vehicle sensor data 110 generated by the vehicle sensors 106 indicating that the refuse container 100 has been inverted over the hopper 104e, the camera 130 can be controlled to capture image data 128.

In some examples, the onboard computing device 112 receives image data 128 from the camera 130 continuously or at designated intervals. The onboard computing device 112 can analyze the image data 128 to identify images that depict a container. The onboard computing device 112 can then analyze the identified images to determine whether agitation of the container is recommended in order to dislodge refuse from the container 100.

The process 400 optionally includes estimating a volume of refuse dumped from the refuse container into the vehicle hopper (409). The onboard computing device 112 can estimate the volume of the refuse dumped into the vehicle hopper using the image data 128.

In some examples, the onboard computing device 112 can track volume of refuse collected from individual refuse containers. In some implementations, the onboarding computing device 112 of the vehicle 102 can estimate, track, and monitor the volume of refuse collected by the vehicle 102 over time (e.g., while the vehicle 102 is on route) based on estimating the volume of refuse dumped from the refuse container into the vehicle hopper. In some examples, the onboard computing device 112 can track total volume of refuse unloaded into the hopper 104e. For example, the onboard computing device 112 can use the vehicle sensor data 110, image data 128, temperature data 138, location data, or any combination thereof to estimate and track refuse volume within the storage body 104f of the refuse vehicle.

In some examples, the onboard computing device 112 monitors containers to estimate fill levels of the containers and to identify overloaded containers. For example, the onboard computing device 112 can analyze the image data 128 from the camera 130 to determine that the container 100 is overloaded when the container 100 is first raised above the hopper 104e. An overloaded container can be, for example, a container that is filled above a maximum threshold volume for the container, as determined based on processing image data 128 depicting the container. In some examples, an overloaded container is filled above a side of the container, or is filled above a fill line of the container. In some implementations, the vehicle sensors 106 include one or more weight sensors configured to determine a weight of the refuse container, and the determination the fill level of the refuse container is determined based on the weight of the refuse container detected by the one or more weight sensors.

In response to determining that the container 100 is overloaded when the container 100 is raised above the hopper 104e, the onboard computing device 112 can store data indicating that the container 100 is overloaded. The data can be stored with an associated identifier for the container 100. The identifier can include, for example, an identification number obtained from the image data 128 and/or a geographical location where the container 100 was picked up. In addition, in some implementations, the fill level of the refuse container as determined based on the vehicle sensor data 110 and/or the image data 128, can be stored with an associated identifier for the container 100.

In some examples, in response to determining that the container 100 is overloaded when the container 100 is raised above the hopper 104e, the onboard computing device 112 can transmit a notification to another computing device. For example, the onboard computing device 112 can transmit a notification to an owner of the container 100 and/or to a service provider that owns and/or operates the vehicle 102 indicating that the container 100 is overloaded.

In some examples, based on estimating the volume of refuse dumped from the refuse container into the vehicle hopper (409), the onboard computing device 112 or another computing device can monitor fill levels of containers over time. For example, the vehicle 102 may service a particular container 100 on a weekly basis. Each time the container 100 is serviced by the vehicle 102, the vehicle sensor data 110 and/or image data 128 generated while servicing the container 100 can be used to determine the fill level of the container 100, and the onboard computing device 112 can store data indicating which weeks that the container 100 is overloaded. At the end of a specified time period (e.g., a month), the service provider can send a message to an owner of the container 100 notifying the owner of the weeks during which the container 100 was overloaded. In some examples, the service provider can bill the owner of the container 100 according to fill levels of the container 100. For example, the service provider may charge an extra fee each time the container 100 is overloaded, may charge extra fees for repeatedly overloading the container 100, or both.

In some examples, based on estimating the volume of refuse dumped from the refuse container into the vehicle hopper (409), the onboard computing device 112 can estimate the volume of refuse within each container collected along a collection route and can estimate the total volume of refuse contained within the storage body 104f of the vehicle 102 based on the estimated volume of refuse within the serviced refuse containers. For example, the onboard computing device 112 can obtain, from the camera 130, image data 128 depicting interiors of each container serviced by the vehicle during unloading of the containers into the hopper 104e. The onboard computing device 112 can analyze the image data 128 collected for each container that is unloaded into the hopper 104e. Based on the analysis, the onboard computing device 112 can estimate the volume of refuse input into the hopper 104e from each of the containers serviced by the vehicle 102. The onboard computing device 112 can use the estimated volume of each container serviced by the vehicle 102 to estimate a total volume of refuse that has been unloaded into the hopper 104e.

The onboard computing device 112 can generate recommended routes based on the estimated total volume of refuse within the storage body 104f of the vehicle 102. For example, the onboard computing device 112 can use the estimated total volume of refuse within the storage body 104f of the vehicle 102 to predict a number of additional containers that can be unloaded before the hopper 104e is full. The onboard computing device can then generate a recommended route for the vehicle 102 in which the vehicle 102 collects the predicted number of additional containers before transiting to a refuse collection facility.

In some examples, based on estimating the volume of refuse dumped from the refuse container into the vehicle hopper, the onboard computing device 112 compares the estimated total volume of refuse in the storage body 104f of the vehicle 102 to a threshold volume for the storage body 104f. In response to determining that the estimated total volume of refuse in the storage body 104f satisfies or exceeds the threshold volume, the onboard computing device 112 can route the refuse collection vehicle 102 to the refuse collection facility.

The process 400 includes determining whether agitation of the refuse container 100 is recommended to dislodge the refuse (410). For example, the onboard computing device 112 can determine, based on the image data 128, whether agitation of the refuse container 100 is recommended to dislodge refuse from the container 100. In some examples, the onboard computing device 112 determines whether agitation of the refuse container 100 is recommended based on the image data 128 and the temperature data 138.

In some examples, the onboard computing device 112 provides the image data 128 as input to a container analysis model trained, using machine learning algorithms, to output a classification of the image data. The container analysis model can be stored and/or run on the ML engine 136. The classification can indicate a degree of emptiness of the refuse container 100. In some examples, the degree of emptiness can be represented by a numerical scale (e.g., zero percent empty to one hundred percent empty). In addition to or instead of a degree of emptiness, the classification can indicate a degree of fullness of the refuse container 100 (e.g., zero percent full to one hundred percent full). For example, a container that is zero percent empty can be classified as being one hundred percent full. In some examples, the degree of emptiness or fullness can be represented by a non-numerical scale (e.g., completely full, mostly full, half empty, mostly empty, completely empty). In some implementations, the classification can indicate whether the container is empty or not (e.g., empty or not empty).

In some examples, the onboard computing device 112 provides the image data 128 and temperature data 138 as input to a container analysis model trained, using machine learning algorithms, to output a classification of the image data. The classification can indicate whether or not agitation of the refuse container 100 is recommended to dislodge refuse from the container 100.

The onboard computing device 112 can compare the degree of emptiness to an emptiness threshold. The emptiness threshold can be a numerical threshold (e.g., eighty-five percent empty) or a non-numerical threshold (e.g., mostly empty).

In some implementations, the onboard computing device 112 can determine that agitation of the refuse container is recommended (411) based at least partly on determining that the container is not empty. In some implementations, the onboard computing device 112 can determine that agitation of the refuse container is recommended (411) based on determining that the degree of emptiness of the refuse container does not satisfy an emptiness threshold. For example, the onboard computing device 112 may determine that the degree of emptiness of the container 100 is seventy-percent empty, the emptiness threshold is eighty-five percent empty, and therefore that the container 100 does not satisfy the emptiness threshold. In another example, the onboard computing device 112 may determine that the degree of emptiness of the container 100 is half empty, the emptiness threshold is a mostly empty classification, and therefore that the container 100 does not satisfy the emptiness threshold. In response to determining the degree of emptiness of the refuse container does not satisfy the emptiness threshold, the onboard computing device 112 can determine that agitation of the refuse container 100 is recommended to dislodge the refuse from the refuse container 100.

In some implementations, the onboard computing device 112 can determine that agitation of the refuse container is not recommended (415) based at least partly on determining that the container is empty. In some implementations, the onboard computing device 112 can determine that agitation of the refuse container is not recommended (415) based at least partly on determining that the degree of emptiness of the refuse container satisfies the emptiness threshold. For example, the onboard computing device 112 may determine that the degree of emptiness of the container 100 is ninety-percent empty, the emptiness threshold is eighty-five percent empty, and therefore that the container 100 satisfies the emptiness threshold. In another example, the onboard computing device 112 may determine that the degree of emptiness of the container 100 is completely empty and that the emptiness threshold is mostly empty, and therefore that the container 100 satisfies the emptiness threshold. In response to determining the degree of emptiness of the refuse container satisfies the emptiness threshold, the onboard computing device 112 can determine that agitation of the refuse container 100 is not recommended to dislodge the refuse from the refuse container 100 (415).

In some examples, the onboard computing device 112 determines whether agitation of the refuse container 100 is recommended to dislodge the refuse from the refuse container 100 based at least partly on comparing the environmental temperature indicated by the temperature data 138 to a temperature threshold. The threshold temperature can be, for example, thirty two degrees Fahrenheit (zero degrees Celsius). The onboard computing device 112 can determine that the environmental temperature is below a threshold temperature and that a degree of emptiness of the refuse container does not satisfy a threshold degree of emptiness and, in response to determining that the environmental temperature is below the threshold temperature and that the degree of emptiness of the refuse container does not satisfy the threshold degree of emptiness, the onboard computing device 112 can determine that agitation of the refuse container 100 is recommended to dislodge the refuse from the refuse container (411).

In some examples, the onboard computing device 112 can determine that the environmental temperature is above a threshold temperature, that a degree of emptiness of the refuse container satisfies the threshold degree of emptiness, or both. In response to determining that the environmental temperature is above the threshold temperature and/or that the degree of emptiness of the refuse container satisfies the threshold degree of emptiness, the onboard computing device 112 can determine that agitation of the refuse container 100 is not recommended to dislodge the refuse from the refuse container (415).

The process 400 includes, in response to determining that agitation of the refuse container 100 is recommended (411), initiating agitation of the refuse container 100 (412).

In some examples, initiating agitation of the refuse container 100 (412) includes providing a notification to recommend agitation. For example, the onboard computing device 112 can provide the agitation notification 144 to the computing device 126. In some examples, the notification 144 includes a visual notification presented on a display in the cab 104g. In some examples, the notification 144 includes a light illuminated inside the cab 104g, an audible notification broadcast inside the cab 104g, or any combination of these.

In some examples, the notification 144 indicates an amount of agitation recommended to dislodge refuse from the container 100. For example, the notification can indicate a duration of agitation (e.g., five seconds, ten seconds, etc.) or a number of times to shake the container (e.g., one time, two times, etc.).

In some examples, in response to the notification, a user can operate the lift arm assembly 160 to agitate the container, as described with reference to FIGS. 2A and 2B. For example, the operator 206 can operate a joystick to maneuver the pair of lift arms 104a, the fork assembly 104 b, or both. In some examples, the cab 104g of the refuse collection vehicle 102 includes an interface element associated with agitation. The interface element can include, for example, a graphical user interface icon, a button, or a switch that, when operated by a user, automatically shakes the container 100. In some examples, agitation initiated using the interface element is pre-set to a specified duration or number of shakes. For example, the vehicle 102 can be pre-set to shake the container 100 twice when the operator 206 operates the interface element associated with agitation. In another example, the vehicle 102 can be pre-set to shake the container 100 for ten seconds when the operator 206 operates the interface element associated with agitation.

In some examples, initiating agitation of the container 100 (412) includes controlling a lift arm assembly to agitate the container. For example, the onboard computing device 112 can output an agitation control signal 142 to one or more actuators 140 that causes the lift arm assembly 160 to move automatically to agitate the refuse container 100.

In some examples, initiating agitation of the container 100 (412) includes controlling hydraulic flow valves to adjust a cushioning level of a cushion function of an actuator 140. For example, the onboard computing device 112 can output an agitation control signal 142 to one or more actuators 140 that cause the cylinder cushion function to turn off or to progressively adjust to a reduced cushioning level. After adjusting the cushioning level of the cylinder cushion function, the container 100 can be agitated by automatic action or by manual action performed by an operator.

The process 400 can optionally be repeated. For example, after providing the notification to recommend agitation, after controlling the lift arm assembly 160 to agitate the container 100, or after both, the onboard computing device 112 can repeat (420) the steps of obtaining image data 128 from the camera 130 depicting the interior of the refuse container 100 (408) and determining, based on the image data 128, whether additional agitation of the refuse container 100 is recommended to dislodge the refuse from the refuse container 100 (410). In response to determining whether agitation of the refuse container 100 is recommended to dislodge the refuse from the refuse container 100, the onboard computing device 112 can initiate agitation of the refuse container 100 (412) a second time by providing a notification 144 of the recommendation, controlling the lift arm assembly 160 to agitate the container 100, or both.

In some examples, in response to determining that additional agitation of the refuse container 100 is recommended, the onboard computing device 112 can provide another notification 144 indicating that additional agitation of the refuse container 100 is recommended. In response to determining that additional agitation of the refuse container 100 is not recommended, the onboard computing device can provide a notification 144 indicating that no additional agitation of the refuse container 100 is recommended, and/or can clear the original notification 144 that recommended agitation.

The process 400 can be repeated multiple times. In some examples, the process 400 is repeated until the onboard computing device 112 determines that additional agitation of the refuse container 100 is not recommended to dislodge the refuse from the refuse container. In some examples, the process 400 is repeated until a maximum threshold time has expired. The maximum threshold time can be, for example, a maximum number of seconds for unloading the container 100 (e.g., sixty seconds, one hundred twenty seconds, etc.). In some examples, the maximum threshold time is a maximum number of agitations or “shakes” of the container (e.g., two shakes, three shakes, etc.). When the computing device 112 determines that additional agitation of the refuse container 100 is not recommended to dislodge the refuse from the refuse container or the maximum threshold time has expired, the refuse collection vehicle can be controlled to return the container 100 to the ground.

The process 400 includes, in response to determining that agitation of the refuse container 100 is not recommended (415), preventing agitation of the refuse container 100 (416).

In some examples, preventing agitation of the refuse container 100 includes providing a notification to recommend no agitation of the refuse container 100. For example, the onboard computing device 112 can provide, to an operator 206 of the refuse collection vehicle 102, a notification 144 that agitation of the refuse container 100 is not recommended.

In some examples, preventing agitation of the refuse container 100 includes controlling a lift arm assembly to prevent agitation of the container. For example, in response to determining that agitation of the refuse container is not recommended, the onboard computing device 112 can output a control signal to the one or more actuators 140 that prevents the lift arm assembly 160 from moving to agitate the refuse container 100. For example, the agitation control signal 142 may permit the lift arm assembly 160 to move downwards along the path 150 towards the ground 121, and prevent the lift arm assembly from moving upwards along the path 150. In some examples, to prevent agitation of the refuse container 100, the onboard computing device 112 outputs an agitation control signal 142 to the one or more actuators 140 that causes the lift arm assembly 160 to automatically move to lower the refuse container 100 to the ground 121.

In some implementations, the onboard computing device is a multi-purpose hardware platform. The device can include a UDU (Gateway) and/or a window unit (WU) (e.g., camera) to record video and/or audio operational activities of the vehicle. The onboard computing device hardware subcomponents can include, but are not limited to, one or more of the following: a CPU, a memory or data storage unit, a CAN interface, a CAN chipset, NIC(s) such as an Ethernet port, USB port, serial port, I2c lines(s), and so forth, I/O ports, a wireless chipset, a GPS chipset, a real-time clock, a micro SD card, an audio-video encoder and decoder chipset, and/or external wiring for CAN and for I/O. The device can also include temperature sensors, battery and ignition voltage sensors, motion sensors, an accelerometer, a gyroscope, an altimeter, a GPS chipset with or without dead reckoning, and/or a digital can interface (DCI). The DCI cam hardware subcomponent can include the following: CPU, memory, can interface, can chipset, Ethernet port, USB port, serial port, I2c lines, I/O ports, a wireless chipset, a GPS chipset, a real-time clock, and external wiring for CAN and/or for I/O. In some implementations, the onboard computing device is a smartphone, tablet computer, and/or other portable computing device that includes components for recording video and/or audio data, processing capacity, transceiver(s) for network communications, and/or sensors for collecting environmental data, telematics data, and so forth.

The onboard computing device can determine the speed and/or location of the vehicle using various techniques. CAN_SPEED can be determined using the CAN interface and using J1939 or J1962, reading wheel speed indicator. The wheel speed can be created by the vehicle ECU. The vehicle ECU can have hardware connected to a wheel axle and can measure rotation with a sensor. GPS_SPEED can provide data from GPS and be linked, such as to a minimum of three satellites and a fourth satellite to determine altitude or elevation. Actual coordinates of the vehicle on the map can be plotted and/or verified, to determine the altitude of vehicle. SENSOR_SPEED can be provided using motion sensors, such as accelerometer, gyroscope, and so forth. These hardware components may sample at high frequency and may be used to measure delta, rate of acceleration, and derive speed from the measurements. Other speed sensors can also be used. LOCATION_WITH_NO_GPS can be provided using the GPS chipset with dead reckoning, and can derive actual vehicle location and movement by using a combination of SENSOR_SPEED and CAN_SPEED. Even if GPS is not available, some systems can determine accurately where the vehicle is based on such dead reckoning.

Although examples herein may show and/or describe implementations for particular types of refuse collection vehicles, implementations are not limited to these examples. The structures and/or methods described herein can apply to any suitable type of refuse collection vehicle, including front-loader, rear-loader, side-loader, roll-off, and so forth, with or without Curotto-Can™, carry can, and so forth.

FIG. 5 shows an example computing system. The system 500 may be used for any of the operations described with respect to the various implementations discussed herein. For example, the system 500 may be included, at least in part, in one or more of the onboard computing device 112, the computing device(s) 126, and/or other computing device(s) or system(s) described herein. The system 500 may include one or more processors 510, a memory 520, one or more storage devices 530, and one or more input/output (I/O) devices 550 controllable via one or more I/O interfaces 540. The various components 510, 520, 530, 540, or 550 may be interconnected via at least one system bus 560, which may enable the transfer of data between the various modules and components of the system 500.

The processor(s) 510 may be configured to process instructions for execution within the system 500. The processor(s) 510 may include single-threaded processor(s), multi-threaded processor(s), or both. The processor(s) 510 may be configured to process instructions stored in the memory 520 or on the storage device(s) 530. For example, the processor(s) 510 may execute instructions for the various software module(s) described herein. The processor(s) 510 may include hardware-based processor(s) each including one or more cores. The processor(s) 510 may include general purpose processor(s), special purpose processor(s), or both.

The memory 520 may store information within the system 500. In some implementations, the memory 520 includes one or more computer-readable media. The memory 520 may include any number of volatile memory units, any number of non-volatile memory units, or both volatile and non-volatile memory units. The memory 520 may include read-only memory, random access memory, or both. In some examples, the memory 520 may be employed as active or physical memory by one or more executing software modules.

The storage device(s) 530 may be configured to provide (e.g., persistent) mass storage for the system 500. In some implementations, the storage device(s) 530 may include one or more computer-readable media. For example, the storage device(s) 530 may include a floppy disk device, a hard disk device, an optical disk device, or a tape device. The storage device(s) 530 may include read-only memory, random access memory, or both. The storage device(s) 530 may include one or more of an internal hard drive, an external hard drive, or a removable drive.

One or both of the memory 520 or the storage device(s) 530 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 500. In some implementations, the CRSM may include a data store that provides storage of computer-readable instructions or other information in a non-transitory format. The CRSM may be incorporated into the system 500 or may be external with respect to the system 500. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 510 and the memory 520 may be supplemented by, or incorporated into, one or more application-specific integrated circuits (ASICs).

The system 500 may include one or more I/O devices 550. The I/O device(s) 550 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 550 may also include one or more output devices such as a display, LED(s), an audio output device (e.g., a speaker), a printer, a haptic output device, and so forth. The I/O device(s) 550 may be physically incorporated in one or more computing devices of the system 500, or may be external with respect to one or more computing devices of the system 500.

The system 500 may include one or more I/O interfaces 540 to enable components or modules of the system 500 to control, interface with, or otherwise communicate with the I/O device(s) 550. The I/O interface(s) 540 may enable information to be transferred in or out of the system 500, or between components of the system 500, through serial communication, parallel communication, or other types of communication. For example, the I/O interface(s) 540 may comply with a version of the RS-232 standard for serial ports, or with a version of the IEEE 1284 standard for parallel ports. As another example, the I/O interface(s) 540 may be configured to provide a connection over Universal Serial Bus (USB) or Ethernet. In some examples, the I/O interface(s) 540 may be configured to provide a serial connection that is compliant with a version of the IEEE 1394 standard.

The I/O interface(s) 540 may also include one or more network interfaces that enable communications between computing devices in the system 500, or between the system 500 and other network-connected computing systems. The network interface(s) may include one or more network interface controllers (NICs) or other types of transceiver devices configured to send and receive communications over one or more communication networks using any network protocol.

Computing devices of the system 500 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 500 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Waste (refuse) collection can include, but is not limited to, the collection of garbage (e.g., to transport to a landfill), recyclables (e.g., to transport to a recycling facility), and/or yard waste (e.g., to transport to a mulching facility). Waste collection can include collection from residential sites (e.g., small bins), commercial sites (e.g., large bins), and/or other types of sites.

The waste collection vehicles (e.g., trucks) can include a variety of truck types (e.g., front-loader, side-loader, rear-loader, etc.). Different data may be available in different types of trucks, based on the different telemetry collected, differing numbers of sensors, different types of sensors, and so forth. Different trucks may also provide different computing environment, such as environments that support one or more of the following: data streaming, data recording, data recording and uploading, single CPU, distributed computing, and so forth. Different communications systems may be supported by different trucks, such as communications that vary with respect to bandwidth, cost, medium, and so forth.

Entities interacting with the systems can include, but are not limited to, one or more of the following: truck driver/crew, event reviewer, quality control manager (e.g., reviewing validity of the driver and reviewer), truck driver/crew trainer, customer service agents, customers (e.g., residents, businesses, and/or municipalities with waste bins collected by trucks), waste collection service providers (e.g., public municipalities, private companies), and/or facility managers.

As used herein, a real time process or operation describes a process or operation that is performed in response to detecting a triggering condition (e.g., event), in which the real time process is performed without any unnecessary delay following the triggering condition, apart from the delay that is incurred due to the limitations (e.g., speed, bandwidth) of any networks being used, transfer of data between system components, memory access speed, processing speed, and/or computing resources. A real time process or operation may be performed within a short period of time following the detection of the triggering condition, and/or may be performed at least partly concurrently with the triggering condition. A triggering condition may be the receipt of a communication, the detection of a particular system state, and/or other types of events. In some instances, a real time process is performed within a same execution path, such as within a same process or thread, as the triggering condition. In some instances, a real time process is performed by a different process or thread that is created or requested by a process that detects the triggering condition. A real time process may also be described as synchronous with respect to the triggering condition.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

What is claimed is:

1. A refuse collection vehicle, comprising:
a wheeled chassis;
a hopper supported on the wheeled chassis;
a lift arm assembly configured to unload refuse from a refuse container into the hopper, wherein the lift arm assembly is movable by one or more actuators;
a camera mounted to the refuse collection vehicle; and
a control system communicably coupled to the camera and the one or more actuators, the control system comprising one or more processors and a data store coupled to the one or more processors having instructions stored thereon which, when executed by the one or more processors, causes the one or more processors to perform operations comprising:
obtaining, from the camera, image data depicting an interior of the refuse container after the lift arm assembly has raised the refuse container to dump the refuse into the hopper;
determining, based on the image data, whether agitation of the refuse container is recommended to dislodge the refuse from the refuse container; and
in response to determining whether agitation of the refuse container is recommended to dislodge the refuse from the refuse container, causing the refuse collection vehicle to perform one or more actions.

2. The refuse collection vehicle of claim 1, wherein determining, based on the image data, whether agitation of the refuse container is recommended to dislodge the refuse from the refuse container comprises determining that agitation of the refuse container is recommended to dislodge the refuse from the refuse container.

3. The refuse collection vehicle of claim 2, the operations comprising:
in response to determining that agitation of the refuse container is recommended to dislodge the refuse from the refuse container, outputting a control signal to the one or more actuators that causes the lift arm assembly to move automatically to agitate the refuse container.

4. The refuse collection vehicle of claim 3, the operations comprising:
determining, based on the image data, a duration of agitation of the refuse container, wherein the control signal causes the lift arm assembly to move automatically to agitate the refuse container for the determined duration.

5. The refuse collection vehicle of claim 2, the operations comprising:
in response to determining that agitation of the refuse container is recommended to dislodge the refuse from the refuse container, generating a notification that agitation of the refuse container is recommended, wherein the notification comprises at least one of:
a visual notification presented on a display inside a cab of the refuse collection vehicle;
a light illuminated inside the cab of the refuse collection vehicle; or
an audible notification broadcast inside the cab of the refuse collection vehicle.

6. The refuse collection vehicle of claim 2, the operations comprising:
repeatedly:
after causing the refuse collection vehicle to perform the one or more actions, obtaining, from the camera, additional image data depicting the interior of the refuse container;
determining, based on the additional image data, whether additional agitation of the refuse container is recommended to dislodge the refuse from the refuse container; and
in response to determining whether agitation of the refuse container is recommended to dislodge the refuse from the refuse container, causing the refuse collection vehicle to perform one or more actions,
until determining that additional agitation of the refuse container is not recommended to dislodge the refuse from the refuse container.

7. The refuse collection vehicle of claim 1, wherein determining, based on the image data, whether agitation of the refuse container is recommended to dislodge the refuse from the refuse container comprises determining that agitation of the refuse container is not recommended to dislodge the refuse from the refuse container.

8. The refuse collection vehicle of claim 7, the operations comprising:
in response to determining that agitation of the refuse container is not recommended to dislodge the refuse from the refuse container, outputting a control signal to the one or more actuators that prevents the lift arm assembly from moving to agitate the refuse container.

9. The refuse collection vehicle of claim 7, the operations comprising:
in response to determining that agitation of the refuse container is not recommended to dislodge the refuse from the refuse container, outputting a control signal to the one or more actuators that causes the lift arm assembly to automatically move to lower the refuse container to the ground.

10. The refuse collection vehicle of claim 7, the operations comprising:
in response to determining that agitation of the refuse container is not recommended to dislodge the refuse from the refuse container, generating a notification that agitation of the refuse container is not recommended, wherein the notification comprises at least one of:
a visual notification presented on a display inside a cab of the refuse collection vehicle;
a light illuminated inside the cab of the refuse collection vehicle; or
an audible notification broadcast inside the cab of the refuse collection vehicle.

11. The refuse collection vehicle of claim 1, further comprising a lift arm sensor configured to generate lift arm sensor data indicating an operational state of the lift arm assembly, the operations comprising:
obtaining, from the lift arm sensor, the lift arm sensor data; and
determining, using the lift arm sensor data, that a position of the lift arm assembly satisfies position criteria,
wherein obtaining the image data from the camera is performed in response to determining that that the position of the lift arm assembly satisfies the position criteria.

12. The refuse collection vehicle of claim 11, wherein determining, using the lift arm sensor data, that the position of the lift arm assembly satisfies position criteria comprises determining that the lift arm assembly is holding the refuse container in an inverted position.

13. The refuse collection vehicle of claim 11, wherein determining, using the lift arm sensor data, that the position of the lift arm assembly satisfies position criteria comprises:
determining a time duration that the lift arm assembly has held the refuse container in an inverted position; and
determining that the time duration satisfies a threshold time duration.

14. The refuse collection vehicle of claim 1, wherein determining, based on the image data, whether agitation of the refuse container is recommended to dislodge the refuse from the refuse container comprises:
providing the image data as input to at least one container analysis model trained, using at least one machine learning (ML) algorithm, to output a classification of the image data, wherein the classification indicates a degree of emptiness of the refuse container.

15. The refuse collection vehicle of claim 14, wherein determining, based on the image data, whether agitation of the refuse container is recommended to dislodge the refuse from the refuse container comprises:
determining that the degree of emptiness of the refuse container does not satisfy an emptiness threshold; and
in response to determining the degree of emptiness of the refuse container does not satisfy the emptiness threshold, determining that agitation of the refuse container is recommended to dislodge the refuse from the refuse container.

16. The refuse collection vehicle of claim 14, wherein determining, based on the image data, whether agitation of the refuse container is recommended to dislodge the refuse from the refuse container comprises:
determining that the degree of emptiness of the refuse container satisfies an emptiness threshold; and
in response to determining the degree of emptiness of the refuse container satisfies the emptiness threshold, determining that agitation of the refuse container is not recommended to dislodge the refuse from the refuse container.

17. The refuse collection vehicle of claim 1, the operations comprising:
obtaining identifying information for the refuse container;
determining, using the image data, an estimated volume of the refuse in the refuse container;
storing data including the identifying information for the refuse container and the estimated volume of the refuse in the refuse container;
determining that the estimated volume of the refuse in the refuse container exceeds a threshold volume for the refuse container; and
in response to determining that the estimated volume of the refuse in the refuse container exceeds the threshold volume for the refuse container, transmitting a notification to a customer associated with the refuse container indicating that the estimated volume exceeds the threshold volume for the refuse container.

18. The refuse collection vehicle of claim 1, the operations comprising:
obtaining, from the camera, image data depicting interiors of a plurality of containers serviced by the refuse collection vehicle during servicing of the plurality of containers;
determining, using the image data, a respective estimated volume of the refuse in each of the plurality of containers;
determining an estimated volume of refuse within a storage body of the refuse collection vehicle based on the respective estimated volumes of the refuse in each of the plurality of containers;
determining that the estimated volume of the refuse within the storage body of the refuse collection vehicle satisfies a threshold volume for the storage body; and
in response to determining that the estimated volume of the refuse within the storage body of the refuse collection vehicle satisfies the threshold volume for the storage body, routing the refuse collection vehicle to a refuse collection facility.

19. The refuse collection vehicle of claim 1, further comprising a light source configured to illuminate the interior of the refuse container when unloading the refuse from the refuse container into the hopper.

20. The refuse collection vehicle of claim 1, wherein the control system comprises an onboard computing device located in the refuse collection vehicle.

21. The refuse collection vehicle of claim 1, further comprising a temperature sensor, the operations comprising:
obtaining, from the temperature sensor, temperature data indicating an environmental temperature at a location of the refuse collection vehicle,
wherein the determining whether agitation of the refuse container is recommended to dislodge the refuse from the refuse container is based on the image data and the temperature data.

22. The refuse collection vehicle of claim 21, wherein determining, based on the image data and the temperature data, whether agitation of the refuse container is recommended to dislodge the refuse from the refuse container comprises providing the image data and the temperature data as input to at least one container analysis model trained, using at least one machine learning (ML) algorithm, to output a classification of the input, wherein the classification indicates whether agitation of the refuse container is recommended.

23. The refuse collection vehicle of claim 21, the operations comprising:
determining, based on the temperature data, that the environmental temperature at the location of the refuse collection vehicle is below a threshold temperature;
determining, based on the image data, that a degree of emptiness of the refuse container does not satisfy a threshold degree of emptiness; and
in response to determining that the environmental temperature at the location of the refuse collection vehicle is below a threshold temperature and the degree of emptiness of the refuse container does not satisfy the threshold degree of emptiness, determining that agitation of the refuse container is recommended to dislodge the refuse from the refuse container.

24. A method, comprising:
obtaining, from a camera mounted to a refuse collection vehicle, image data depicting an interior of a refuse container while the refuse container is inverted over a hopper of the refuse collection vehicle;
determining, based on the image data, whether agitation of the refuse container is recommended to dislodge refuse from the refuse container; and
in response to determining whether agitation of the refuse container is recommended to dislodge refuse from the refuse container, causing the refuse collection vehicle to perform one or more actions.
